(19) United States
(12) Patent Application Publication
(10) Pub. No.: US 2023/0396367 A1
(43) Pub. Date: Dec. 7, 2023

(54) TERMINAL APPARATUS, BASE STATION APPARATUS, AND METHOD

(71) Applicant: SHARP KABUSHIKI KAISHA, Sakai City, Osaka (JP)

(72) Inventors: Takako HORI, Sakai City, Osaka (JP); SHOHEI YAMADA, Sakai City, Osaka (JP); HIDEKAZU TSUBOI, Sakai City, Osaka (JP); Kyosuke INOUE, Sakai City, Osaka (JP)

(21) Appl. No.: 18/032,309

(22) PCT Filed: Oct. 18, 2021
(86) PCT No.: PCT/JP2021/038472

§ 371 Date: Apr. 17, 2023

(30) Foreign Application Priority Data
Oct. 21, 2020 (JP) 2020-176502

(51) Int. Cl. H04L 1/1607; H04W 72/30

(52) U.S. Cl. CPC H04L 1/1642; H04W 72/30; H04W 80/02

(57) ABSTRACT

A terminal apparatus includes a receiver configured to receive data from a base station apparatus, and a processing unit. The processing unit maintains a first state variable in a receiving PDCP entity of the terminal apparatus, and performs processing of, in the maintaining, setting, based on a fact that the data to be received from the base station apparatus is data of an MBS, an initial value of a sequence number part of the first state variable as a first value and setting based on a fact that the data to be received from the base station apparatus is at least not the data of the MBS, the initial value of the first state variable to 0.

### TECHNICAL FIELD

The present invention relates to a terminal apparatus, a base station apparatus, and a method.

This application claims priority to JP 2020-176502 filed on Oct. 21, 2020, the contents of which are incorporated herein by reference.

### BACKGROUND ART

In the 3rd Generation Partnership Project (3GPP) being a standardization project for cellular mobile communication systems, technical study and standardization have been carried out regarding the cellular mobile communication systems including radio access, core networks, services, and the like.

For example, in 3GPP, technical study and standardization have been started on Evolved Universal Terrestrial Radio Access (E-UTRA) as a Radio Access Technology (RAT) for cellular mobile communication systems for the 3.9th generation and the fourth generation. At present as well, in 3GPP, technical study and standardization have been carried out on enhanced technology of E-UTRA. Note that E-UTRA may also be referred to as Long Term Evolution (LTE: trade name), and its enhanced technology may also be referred to as LTE-Advanced (LTE-A) and LTE-Advanced Pro (LTE-A Pro) (e.g., NPL 2).

In 3GPP, technical study and standardization have been started on New Radio or NR Radio access (NR) as a Radio Access Technology (RAT) for cellular mobile communication systems for the fifth generation (5G). At present as well, in 3GPP, technical study and standardization have been carried out on enhanced technology of NR (e.g., NPL 1).

### CITATION LIST

### Non Patent Literature

NPL 1: 3GPP TS 38.300 v 16.2.0, “NR; NR and NG-RAN Overall description; Stage 2” pp. 10-134
NPL 2: 3GPP TS 36.300 v16.2.0, “Evolved Universal Terrestrial Radio Access (E-UTRA) and Evolved Universal Terrestrial Radio Access Network (E-UTRAN); Overall description; Stage 2” pp. 19-361

### SUMMARY OF INVENTION

### Technical Problem

As one aspect of the study of the enhanced technology of E-UTRA, in order to provide multicast/broadcast services, Multimedia Broadcast Multicast Service (MBMS) transmission technology has been standardized. For the MBMS transmission, transmission using a Multicast Broadcast Single Frequency Network (MBSFN) or a Single Cell Point-To-Multipoint (SC-PTM) is used.

In the transmission using the MBSFN, transmission of multicast/broadcast data is performed using a Physical Multicast Channel (PMCH) for each Multicast-Broadcast Single-Frequency Network (MBSFN) area including multiple cells. In contrast, in the transmission using the SC-PTM, transmission of multicast data is performed using a Physical Downlink Shared Channel (PDSCH) for each cell.

At the same time, multicast/broadcast services (Multicast Broadcast Services (MBS)) have been under study as the enhanced technology of NR. In a case that the MBS is performed via NR, technology specific to NR which is different from that of E-UTRA, a core network standardized for 5G, and the like need to be taken into consideration. However, studies have not yet been carried out on detailed operations for efficiently controlling the MBS by using NR.

An aspect of the present invention is made in view of the circumstances described above, and has an object to provide a terminal apparatus, a base station apparatus, and a method that enable efficient control of MBS by using NR.

### Solution to Problem

In order to accomplish the object described above, an aspect of the present invention is contrived to provide the following means. Specifically, an aspect of the present invention is a terminal apparatus for communicating with a base station apparatus. The terminal apparatus includes: a receiver configured to receive data from the base station apparatus; and a processing unit. The processing unit maintains a first state variable in a receiving PDCP entity of the terminal apparatus, and performs processing of, in the maintaining, setting, based on a fact that the data to be received from the base station apparatus is data of an MBS, an initial value of a sequence number part of the first state variable as a first value, and setting, based on a fact that the data to be received from the base station apparatus is at least not the data of the MBS, the initial value of the first state variable to 0. The first state variable is a state variable indicating a COUNT value of a PDCP SDU expected to be received next. The first value is a remainder obtained by dividing, by a second value, a value obtained by incrementing 1 to a sequence number of a PDCP data PDU received first. The second value is 2 to the power of a third value. The third value is a downlink PDCP sequence number size.

An aspect of the present invention is a base station apparatus for communicating with a terminal apparatus. The base station apparatus includes: a transmitter configured to transmit data to the terminal apparatus; and a processing unit. The processing unit maintains, in a receiving PDCP entity of the terminal apparatus, a first state variable, based on the data to be transmitted to the terminal apparatus, and performs processing of, in the maintaining, setting, based on a fact that the data to be transmitted to the terminal apparatus is data of an MBS, an initial value of a sequence number part of the first state variable as a first value, and setting, based on a fact that the data to be transmitted to the terminal apparatus is at least not the data of the MBS, the initial value of the first state variable to 0. The first state variable is a state variable indicating a COUNT value of a PDCP SDU expected to be received by the terminal apparatus next. The first value is a remainder obtained by dividing, by a second value, a value obtained by incrementing 1 to a sequence number of a PDCP data PDU received first by the terminal apparatus. The second value is 2 to the power of a third value. The third value is a downlink PDCP sequence number size.

An aspect of the present invention is a method of a terminal apparatus for communicating with a base station apparatus. The method includes receiving data from the base station apparatus, maintaining a first state variable in a receiving PDCP entity of the terminal apparatus, and performing processing of, in the maintaining, setting, based on a fact that the data to be received from the base station apparatus is data of an MBS, an initial value of a sequence number part of the first state variable as a first value, and setting, based on a fact that the data to be received from the base station apparatus is at least not the data of the MBS, the initial value of the first state variable to 0. The first state variable is a state variable indicating a COUNT value of a PDCP SDU expected to be received next. The first value is a remainder obtained by dividing, by a second value, a value obtained by incrementing 1 to a sequence number of a PDCP data PDU received first. The second value is 2 to the power of a third value. The third value is a downlink PDCP sequence number size.

An aspect of the present invention is a method of a base station apparatus for communicating with a terminal apparatus. The method includes transmitting data to the terminal apparatus, maintaining, in a receiving PDCP entity of the terminal apparatus, a first state variable, based on the data to be transmitted to the terminal apparatus, and performing processing of, in the maintaining, setting, based on a fact that the data to be transmitted to the terminal apparatus is data of an MBS, an initial value of a sequence number part of the first state variable as a first value, and setting, based on a fact that the data to be transmitted to the terminal apparatus is at least not the data of the MBS, the initial value of the first state variable to 0. The first state variable is a state variable indicating a COUNT value of a PDCP SDU expected to be received next by the terminal apparatus. The first value is a remainder obtained by dividing, by a second value, a value obtained by incrementing 1 to a sequence number of a PDCP data PDU received first by the terminal apparatus. The second value is 2 to the power of a third value. The third value is a downlink PDCP sequence number size.

These comprehensive or specific aspects may be implemented in a system, an apparatus, a method, an integrated circuit, a computer program, or a recording medium, or may be implemented in any combination of systems, apparatuses, methods, integrated circuits, computer programs, and recording media.

### Advantageous Effects of Invention

According to an aspect of the present invention, the terminal apparatus, the base station apparatus, and the method can implement efficient MBS control using NR.

### BRIEF DESCRIPTION OF DRAWINGS

FIG. 1 is a schematic diagram of a communication system according to an embodiment of the present invention.

FIG. 2 is a diagram of an example of E-UTRA protocol architecture according to an embodiment of the present invention.

FIG. 3 is a diagram of an example of NR protocol architecture according to an embodiment of the present invention.

FIG. 4 is a diagram illustrating an example of a flow of a procedure for various configurations in RRC according to an embodiment of the present invention.

FIG. 5 is a block diagram illustrating a configuration of a terminal apparatus according to an embodiment of the present invention.

FIG. 6 is a block diagram illustrating a configuration of a base station apparatus according to an embodiment of the present invention.

FIG. 7 is an example of an ASN.1 notation included in a message related to reconfiguration of RRC connection in NR according to an embodiment of the present invention.

FIG. 8 is an example of an ASN.1 notation included in a message related to reconfiguration of RRC connection in E-UTRA according to an embodiment of the present invention.

FIG. 9 is a diagram illustrating a flow of a procedure for configuration of MBMS reception using an SC-PTM.

FIG. 10 is a diagram illustrating an example of an ASN.1 notation representing fields and/or information elements included in a System Information Block Type 20 (SIB20).

FIG. 11 is a diagram illustrating an example of an ASN.1 notation representing fields and/or information elements included in an SC-PTM configuration message (SCPTMConfiguration).

FIG. 12 is a diagram illustrating an example of a flow of an MBS reception procedure in NR according to an embodiment of the present invention.

FIG. 13 is a diagram illustrating an example of a processing method of the terminal apparatus according to an embodiment of the present invention.

### DESCRIPTION OF EMBODIMENTS

Hereinafter, an embodiment of the present invention will be described in detail with reference to the drawings.

LTE (and LTE-A, LTE-A Pro) and NR may be defined as different Radio Access Technologies (RATs). NR may be defined as a technology included in LTE. LTE may be defined as a technology included in NR. LTE that is connectible to NR by using Multi Radio Dual Connectivity (MR-DC) may be distinguished from existing LTE. LTE using a 5GC as a core network may be distinguished from existing LTE using an EPC as a core network. Note that existing LTE may refer to LTE in which a technology standardized in release 15 or later versions of 3GPP is not implemented. An embodiment of the present invention may be applied to NR, LTE, and other RATs. Terms associated with LTE and NR are used in the following description. However, an embodiment of the present invention may be applied to other technologies using other terms. In an embodiment of the present invention, the term “E-UTRA” may be replaced with “LTE,” and the term “LTE” may be replaced with “E-UTRA.”

Note that, in an embodiment of the present invention, terms of each node and entity, processing in each node and entity, and the like in a case that the radio access technology is E-UTRA or NR will be described. However, an embodiment of the present invention may be used for another radio access technology. The terms of each node and entity in an embodiment of the present invention may be other terms.

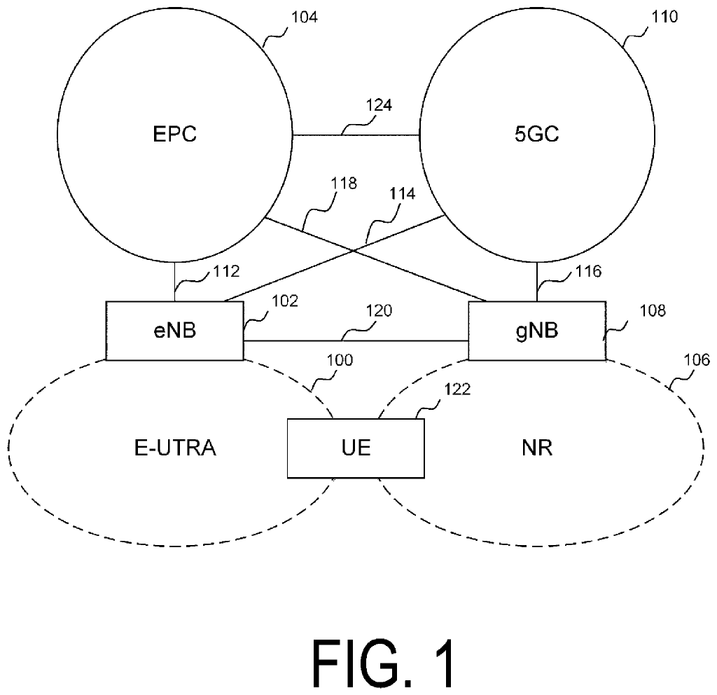

FIG. 1 is a schematic diagram of a communication system according to an embodiment of the present invention. Note that functions such as each node, radio access technology, core network, and interface to be described with reference to FIG. 1 are a part of functions closely related to an embodiment of the present invention, and other functions may be provided.

E-UTRA 100 may be a radio access technology. The E-UTRA 100 may be an air interface between a UE 122 and an eNB 102. The air interface between the UE 122 and the eNB 102 may be referred to as a Uu interface. The E-UTRAN Node B (eNB) 102 may be a base station apparatus of the E-UTRA 100. The eNB 102 may have an E-UTRA protocol to be described below. The E-UTRA protocol may include an E-UTRA User Plane (UP) protocol to be described below and an E-UTRA Control Plane (CP) protocol to be described below. The eNB 102 may terminate the E-UTRA User Plane (UP) protocol and the E-UTRA Control Plane (CP) protocol for the UE 122. A radio access network configured with the eNB may be referred to as an E-UTRAN.

An Evolved Packet Core (EPC) 104 may be a core network. An interface 112 is an interface between the eNB 102 and the EPC 104, and may be referred to as an S1 interface. The interface 112 may include a control plane interface through which a control signal passes and/or a user plane interface through which user data passes. The control plane interface of the interface 112 may be terminated in a Mobility Management Entity (MME) (not illustrated) in the EPC 104. The user plane interface of the interface 112 may be terminated in a serving gateway (S-GW) (not illustrated) in the EPC 104. The control plane interface of the interface 112 may be referred to as an S1-MME interface. The user plane interface of the interface 112 may be referred to as an S1-U interface.

Note that one or multiple eNBs 102 may be connected to the EPC 104 via the interface 112. Among the multiple eNBs 102 connected to the EPC 104, an interface may be present (not illustrated). The interface among the multiple eNBs 102 connected to the EPC 104 may be referred to as an X2 interface.

NR 106 may be a radio access technology. The NR 106 may be an air interface between the UE 122 and a gNB 108. The air interface between the UE 122 and the gNB 108 may be referred to as a Uu interface. The g Node B (gNB) 108 may be a base station apparatus of the NR 106. The gNB 108 may have an NR protocol to be described below. The NR protocol may include an NR User Plane (UP) protocol to be described below and an NR Control Plane (CP) protocol to be described below. The gNB 108 may terminate the NR User Plane (UP) protocol and the NR Control Plane (CP) protocol for the UE 122.

A 5GC 110 may be a core network. An interface 116 is an interface between the gNB 108 and the 5GC 110, and may be referred to as an NG interface. The interface 116 may include a control plane interface through which a control signal passes and/or a user plane interface through which user data passes. The control plane interface of the interface 116 may be terminated in an Access and mobility Management Function (AMF) (not illustrated) in the 5GC 110. The user plane interface of the interface 116 may be terminated in a User Plane Function (UPF) (not illustrated) in the 5GC 110. The control plane interface of the interface 116 may be referred to as an NG-C interface. The user plane interface of the interface 116 may be referred to as an NG-U interface.

Note that one or multiple gNBs 108 may be connected to the 5GC 110 via the interface 116. Among the multiple gNBs 108 connected to the 5GC 110, an interface may be present (not illustrated). The interface among the multiple gNBs 108 connected to the 5GC 110 may be referred to as an Xn interface.

The eNB 102 may have a function of connecting to the 5GC 110. The eNB 102 having the function of connecting to the 5GC 110 may be referred to as an ng-eNB. An interface 114 is an interface between the eNB 102 and the 5GC 110, and may be referred to as an NG interface. The interface 114 may include a control plane interface through which a control signal passes and/or a user plane interface through which user data passes. The control plane interface of the interface 114 may be terminated in an Access and mobility Management Function (AMF) (not illustrated) in the 5GC 110. The user plane interface of the interface 114 may be terminated in a User Plane Function (UPF) (not illustrated) in the 5GC 110. The control plane interface of the interface 114 may be referred to as an NG-C interface. The user plane interface of the interface 114 may be referred to as an NG-U interface. A radio access network including the ng-eNB or the gNB may be referred to as an NG-RAN. The NG-RAN, the E-UTRAN, the eNB, the ng-eNB, the gNB, and the like may be simply referred to as a network.

Note that one or multiple eNBs 102 may be connected to the 5GC 110 via the interface 114. Among the multiple eNBs 102 connected to the 5GC 110, an interface may be present (not illustrated). The interface among the multiple eNBs 102 connected to the 5GC 110 may be referred to as an Xn interface. The eNB 102 connected to the 5GC 110 and the gNB 108 connected to the 5GC 110 may be connected with an interface 120. The interface 120 between the eNB 102 connected to the 5GC 110 and the gNB 108 connected to the 5GC 110 may be referred to as an Xn interface.

The gNB 108 may have a function of connecting to the EPC 104. The gNB 108 having the function of connecting to the EPC 104 may be referred to as an en-gNB. An interface 118 is an interface between the gNB 108 and the EPC 104, and may be referred to as an S1 interface. The interface 118 may include a user plane interface through which user data passes. The user plane interface of the interface 118 may be terminated in an S-GW (not illustrated) in the EPC 104. The user plane interface of the interface 118 may be referred to as an S1-U interface. The eNB 102 connected to the EPC 104 and the gNB 108 connected to the EPC 104 may be connected with the interface 120. The interface 120 between the eNB 102 connected to the EPC 104 and the gNB 108 connected to the EPC 104 may be referred to as an X2 interface.

An interface 124 is an interface between the EPC 104 and the 5GC 110, and may be an interface that allows only the CP, only the UP, or both of the CP and the UP to pass therethrough. A part or all of the interfaces out of the interface 114, the interface 116, the interface 118, the interface 120, the interface 124, and the like may be absent depending on a communication system provided by a communication provider or the like.

The UE 122 may be a terminal apparatus that can receive broadcast information and a paging message transmitted from the eNB 102 and/or the gNB 108. The UE 122 may be a terminal apparatus that can perform radio connection with the eNB 102 and/or the gNB 108. The UE 122 may be a terminal apparatus that can simultaneously perform radio connection with the eNB 102 and radio connection with the gNB 108. The UE 122 may have the E-UTRA protocol and/or the NR protocol. Note that the radio connection may be Radio Resource Control (RRC) connection.

In a case that the UE 122 communicates with the eNB 102 and/or the gNB 108, Radio Bearers (RBs) may be established between the UE 122 and the eNB 102 and/or the gNB 108 to perform radio connection. The radio bearer used for the CP may be referred to as a Signaling Radio Bearer (SRB). The radio bearer used for the UP may be referred to as a data radio bearer (DRB Data Radio Bearer). Each radio bearer may be assigned a radio bearer identity (Identity) (ID). The radio bearer identity for the SRB may be referred to as an SRB identity (SRB Identity or SRB ID). The radio bearer identity for the DRB may be referred to as a DRB identity (DRB Identity or DRB ID).

The UE 122 may be a terminal apparatus that can connect to the EPC 104 and/or the 5GC 110 via the eNB 102 and/or the gNB 108. In a case that a connection destination core network of the eNB 102 and/or the gNB 108 with which the UE 122 performs communication is the EPC 104, each DRB established between the UE 122 and the eNB 102 and/or the gNB 108 may further be uniquely associated with each Evolved Packet System (EPS) bearer passing through the EPC 104. Each EPS bearer may be identified with an EPS bearer identity (Identity or ID). The same QoS may be secured for data, such as an IP packet and an Ethernet (trade name) frame, which passes through the same EPS bearer.

In a case that the connection destination core network of the eNB 102 and/or the gNB 108 with which the UE 122 performs communication is the 5GC 110, each DRB established between the UE 122 and the eNB 102 and/or the gNB 108 may further be associated with one of Packet Data Unit (PDU) sessions established in the 5GC 110. Each PDU session may include one or multiple QoS flows. Each DRB may be associated with (mapped to) one or multiple QoS flows, or may be associated with none of the QoS flows. Each PDU session may be identified with a PDU session Identifier (Identity, or ID). Each QoS flow may be identified with a QoS flow Identifier Identity, or ID). The QoS may be secured for data, such as an IP packet and an Ethernet frame, which passes through the same QoS flow.

The EPC 104 may not include the PDU session(s) and/or the QoS flow(s). The 5GC 110 may not include the EPS bearer(s). In a case that the UE 122 is connected to the EPC 104, the UE 122 may have information of the EPS bearer(s) but may not have information in the PDU session(s) and/or the QoS flow(s). In a case that the UE 122 is connected to the 5GC 110, the UE 122 may have information in the PDU session(s) and/or the QoS flow(s) but may not have information of the EPS bearer(s).

Note that, in the following description, the eNB 102 and/or the gNB 108 is also simply referred to as a base station apparatus, and the UE 122 is also simply referred to as a terminal apparatus or a UE.

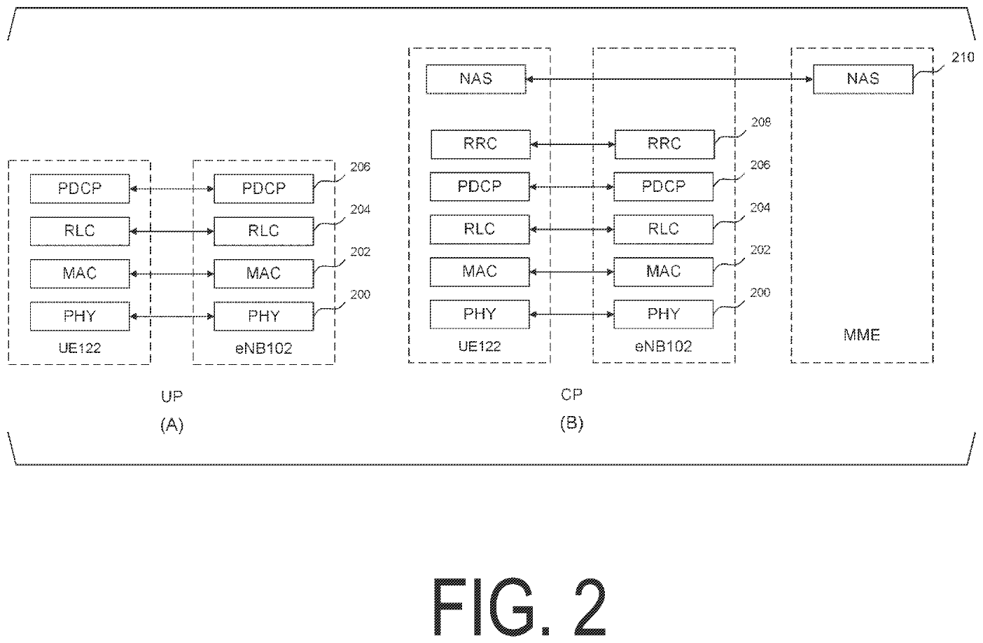

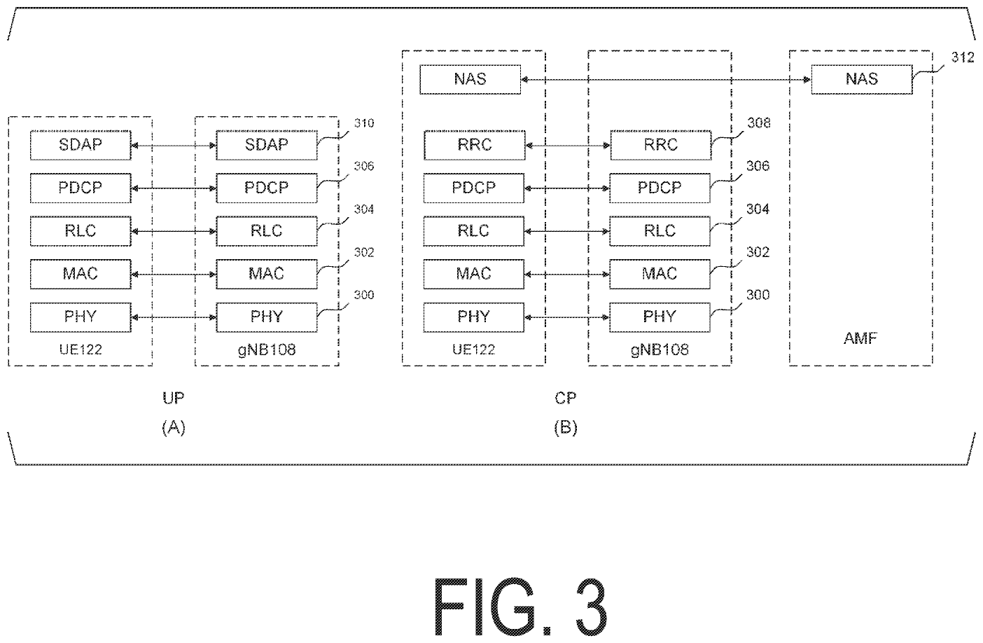

FIG. 2 is a diagram of an example of E-UTRA protocol architecture according to an embodiment of the present invention. FIG. 3 is a diagram of an example of NR protocol architecture according to an embodiment of the present invention. Note that functions of each protocol to be described with reference to FIG. 2 and/or FIG. 3 are a part of functions closely related to an embodiment of the present invention, and other functions may be provided. Note that, in an embodiment of the present invention, an uplink (UL) may be a link from the terminal apparatus to the base station apparatus. In each embodiment of the present invention, a downlink (DL) may be a link from the base station apparatus to the terminal apparatus.

FIG. 2(A) is a diagram of an E-UTRA user plane (UP) protocol stack. As illustrated in FIG. 2(A), the E-UTRAN UP protocol may be a protocol between the UE 122 and the eNB 102. In other words, the E-UTRAN UP protocol may be a protocol terminated in the eNB 102 in a network side. As illustrated in FIG. 2(A), the E-UTRA user plane protocol stack may include a Physical layer (PHY) 200 being a radio physical layer, a Medium Access Control (MAC) 202 being a medium access control layer, a Radio Link Control (RLC) 204 being a radio link control layer, and a Packet Data Convergence Protocol (PDCP) 206 being a packet data convergence protocol layer.

FIG. 3(A) is a diagram of an NR user plane (UP) protocol stack. As illustrated in FIG. 3(A), the NR UP protocol may be a protocol between the UE 122 and the gNB 108. In other words, the NR UP protocol may be a protocol terminated in the gNB 108 in a network side. As illustrated in FIG. 3(A), the E-UTRA user plane protocol stack may include a PHY 300 being a radio physical layer, a MAC 302 being a medium access control layer, an RLC 304 being a radio link control layer, a PDCP 306 being a packet data convergence protocol layer, and a service data adaptation protocol layer SDAP (Service Data Adaptation Protocol) 310.

FIG. 2(B) is a diagram of E-UTRA control plane (CP) protocol architecture. As illustrated in FIG. 2(B), in the E-UTRAN CP protocol, a Radio Resource Control (RRC) 208 being a radio resource control layer may be a protocol between the UE 122 and the eNB 102. In other words, the RRC 208 may be a protocol terminated in the eNB 102 in a network side. In the E-UTRAN CP protocol, a Non Access Stratum (NAS) 210 being a non Access Stratum (AS) layer (non AS layer) may be a protocol between the UE 122 and the MME. In other words, the NAS 210 may be a protocol terminated in the MME in a network side.

FIG. 3(B) is a diagram of NR control plane (CP) protocol architecture. As illustrated in FIG. 3(B), in the NR CP protocol, an RRC 308 being a radio resource control layer may be a protocol between the UE 122 and the gNB 108. In other words, the RRC 308 may be a protocol terminated in the gNB 108 in a network side. In the E-UTRAN CP protocol, a NAS 312 being a non AS layer may be a protocol between the UE 122 and the AMF. In other words, the NAS 312 may be a protocol terminated in the AMF in a network side.

Note that the Access Stratum (AS) layer may be a layer terminated between the UE 122 and the eNB 102 and/or the gNB 108. In other words, the AS layer may be a layer including a part or all of the PHY 200, the MAC 202, the RLC 204, the PDCP 206, and the RRC 208, and/or a layer including a part or all of the PHY 300, the MAC 302, the RLC 304, the PDCP 306, the SDAP 310, and the RRC 308.

Note that, in an embodiment of the present invention, terms such as a PHY (PHY layer), a MAC (MAC layer), an RLC (RLC layer), a PDCP (PDCP layer), an RRC (RRC layer), and a NAS (NAS layer) may be hereinafter used, without the protocol of E-UTRA and the protocol of NR being distinguished from each other. In this case, the PHY (PHY layer), the MAC (MAC layer), the RLC (RLC layer), the PDCP (PDCP layer), the RRC (RRC layer), and the NAS (NAS layer) may be the PHY (PHY layer), the MAC (MAC layer), the RLC (RLC layer), the PDCP (PDCP layer), the RRC (RRC layer), and the NAS (NAS layer) of the E-UTRA protocol, or may be the PHY (PHY layer), the MAC (MAC layer), the RLC (RLC layer), the PDCP (PDCP layer), the RRC (RRC layer), and the NAS (NAS layer) of the NR protocol, respectively. The SDAP (SDAP layer) may be the SDAP (SDAP layer) of the NR protocol.

In an embodiment of the present invention, in a case that the protocol of E-UTRA and the protocol of NR are distinguished from each other, the PHY 200, the MAC 202, the RLC 204, the PDCP 206, and the RRC 208 may be hereinafter referred to as the PHY for E-UTRA or the PHY for LTE, the MAC for E-UTRA or the MAC for LTE, the RLC for E-UTRA or the RLC for LTE, the PDCP for E-UTRA or the PDCP for LTE, and the RRC for E-UTRA or the RRC for LTE, respectively. The PHY 200, the MAC 202, the RLC 204, the PDCP 206, and the RRC 208 may be referred to as an E-UTRA PHY or an LTE PHY, an E-UTRA MAC or an LTE MAC, an E-UTRA RLC or an LTE RLC, an E-UTRA PDCP or an LTE PDCP, an E-UTRA RRC or an LTE RRC, and the like, respectively. In a case that the protocol of E-UTRA and the protocol of NR are distinguished from each other, the PHY 300, the MAC 302, the RLC 304, the PDCP 306, and the RRC 308 may be referred to as a PHY for NR, a MAC for NR, an RLC for NR, an RLC for NR, and an RRC for NR, respectively. The PHY 200, the MAC 302, the RLC 304, the PDCP 306, and the RRC 308 may be referred to as an NR PHY, an NR MAC, an NR RLC, an NR PDCP, an NR RRC, and the like, respectively.

Entities in the AS layer of E-UTRA and/or NR will be described. An entity having a part or all of functions of the MAC layer may be referred to as a MAC entity. An entity having a part or all of functions of the RLC layer may be referred to as an RLC entity. An entity having a part or all of functions of the PDCP layer may be referred to as a PDCP entity. An entity having a part or all of functions of the SDAP layer may be referred to as an SDAP entity. An entity having a part or all of functions of the RRC layer may be referred to as an RRC entity. The MAC entity, the RLC entity, the PDCP entity, the SDAP entity, and the RRC entity may be alternatively referred to as a MAC, an RLC, a PDCP, an SDAP, and an RRC, respectively.

Note that data provided from the MAC, the RLC, the PDCP, and the SDAP to a lower layer, and/or data provided to the MAC, the RLC, the PDCP, and the SDAP from a lower layer may be referred to as a MAC Protocol Data Unit (PDU), an RLC PDU, a PDCP PDU, and an SDAP PDU, respectively. Data provided to the MAC, the RLC, the PDCP, and the SDAP from an upper layer, and/or data provided from the MAC, the RLC, the PDCP, and the SDAP to an upper layer may be referred to as a MAC Service Data Unit (SDU), an RLC SDU, a PDCP SDU, and an SDAP SDU, respectively. A segmented RLC SDU may be referred to as an RLC SDU segment.

An example of the functions of the PHY will be described. The PHY of the terminal apparatus may have a function of receiving data transmitted from the PHY of the base station apparatus via a Downlink (DL) Physical Channel. The PHY of the terminal apparatus may have a function of transmitting data to the PHY of the base station apparatus via an Uplink (UL) physical channel. The PHY may be connected to an upper MAC with a Transport Channel. The PHY may deliver data to the MAC via the transport channel. The PHY may be provided with data from the MAC via the transport channel. In the PHY, in order to identify various pieces of control information, a Radio Network Temporary Identifier (RNTI) may be used.

Now, the physical channels will be described.

The physical channels used for radio communication between the terminal apparatus and the base station apparatus may include the following physical channels.
Physical Broadcast CHannel (PBCH)
Physical Downlink Control CHannel (PDCCH)
Physical Downlink Shared CHannel (PDSCH)
Physical Uplink Control CHannel (PUCCH)
Physical Uplink Shared CHannel (PUSCH)
Physical Random Access CHannel (PRACH)

The PBCH may be used to broadcast system information required by the terminal apparatus.

The PBCH may be used to broadcast time indexes (SSB-Indexes) within the periodicity of synchronization signal blocks (also referred to as SS/PBCH blocks) in NR.

The PDCCH may be used to transmit (or carry) Downlink Control Information (DCI) in downlink radio communication (radio communication from the base station apparatus to the terminal apparatus). Here, one or multiple pieces of DCI (which may be referred to as DCI formats) may be defined for transmission of the downlink control information. In other words, a field for the downlink control information may be defined as DCI and may be mapped to information bits. The PDCCH may be transmitted in PDCCH candidates. The terminal apparatus may monitor a set of PDCCH candidates in a serving cell. To monitor a set of PDCCH candidates may mean an attempt to decode the PDCCH in accordance with a certain DCI format.

The DCI format may be used for scheduling of the PUSCH in the serving cell. The PUSCH may be used for transmission of user data, transmission of RRC messages to be described below, and the like.

The PUCCH is used to transmit Uplink Control Information (UCI) in a case of uplink radio communication (radio communication from the terminal apparatus to the base station apparatus). Here, the uplink control information may include Channel State Information (CSI) used to indicate a downlink channel state. The uplink control information may include a Scheduling Request (SR) used for requesting Uplink Shared CHannel (UL-SCH) resources. The uplink control information may include a Hybrid Automatic Repeat request ACKnowledgement (HARQ-ACK).

The PDSCH may be used to transmit downlink data (Downlink Shared CHannel (DL-SCH)) from the MAC layer. In a case of the downlink, the PDSCH may be used to transmit System Information (SI), a Random Access Response (RAR), and the like.

The PUSCH may be used to transmit uplink data (Uplink-Shared CHannel (UL-SCH)) from the MAC layer or to transmit the HARQ-ACK and/or CSI along with the uplink data. The PUSCH may be used to transmit CSI only or a HARQ-ACK and CSI only. In other words, the PUSCH may be used to transmit the UCI only. The PDSCH or the PUSCH may be used to transmit RRC signalling (also referred to as an RRC message) and a MAC control element. In this regard, in the PDSCH, the RRC signalling transmitted from the base station apparatus may be signalling common to multiple terminal apparatuses in a cell. The RRC signalling transmitted from the base station apparatus may be dedicated signalling for a certain terminal apparatus (also referred to as dedicated signaling). In other words, terminal apparatus-specific (UE-specific) information may be transmitted through dedicated signalling to the certain terminal apparatus. Additionally, the PUSCH may be used to transmit UE capabilities in the uplink.

The PRACH may be used for transmitting a random access preamble. The PRACH may be used for indicating the initial connection establishment procedure, the handover procedure, the connection re-establishment procedure, synchronization (timing adjustment) for uplink transmission, and a request for a PUSCH (UL-SCH) resource.

An example of the functions of the MAC will be described. The MAC may be referred to as a MAC sublayer. The MAC may have a function of mapping various Logical Channels to their corresponding transport channels. The logical channel may be identified with a logical channel identifier (Logical Channel Identity or Logical Channel ID). The MAC may be connected to an upper RLC with a logical channel. The logical channel may be classified into a control channel for transmitting control information and a traffic channel for transmitting user information, depending on a type of information to be transmitted. The logical channel may be classified into an uplink logical channel and a downlink logical channel. The MAC may have a function of multiplexing MAC SDUs belonging to one or multiple different logical channels and providing the multiplexed MAC SDUs to the PHY. The MAC may have a function of demultiplexing the MAC PDUs provided from the PHY and providing the demultiplexed MAC PDUs to an upper layer via the logical channels to which the respective MAC SDUs belong. The MAC may have a function of performing error correction through a Hybrid Automatic Repeat reQuest (HARQ). The MAC may have a Scheduling Report (SR) function of reporting scheduling information. The MAC may have a function of performing priority processing among the terminal apparatuses by using dynamic scheduling. The MAC may have a function of performing priority processing among the logical channels in one terminal apparatus. The MAC may have a function of performing priority processing of resources overlapping in one terminal apparatus. The E-UTRA MAC may have a function of identifying Multimedia Broadcast Multicast Services (MBMS). The NR MAC may have a function of identifying a Multicast Broadcast Service (MBS). The MAC may have a function of selecting a transport format. The MAC may have a function of performing Discontinuous Reception (DRX) and/or Discontinuous Transmission (DTX), a function of performing a Random Access (RA) procedure, a Power Headroom Report (PHR) function of reporting information of transmittable power, a Buffer Status Report (BSR) function of reporting data volume information of a transmission buffer, and the like. The NR MAC may have a Bandwidth Adaptation (BA) function. A MAC PDU format used in the E-UTRA MAC and a MAC PDU format used in the NR MAC may be different from each other. The MAC PDU may include a MAC control element (MAC CE) being an element for performing control in the MAC.

Uplink (UL) and/or Downlink (DL) logical channels used in E-UTRA and/or NR will be described.

A Broadcast Control Channel (BCCH) may be a downlink logical channel for broadcasting control information, such as System Information (SI).

A Paging Control Channel (PCCH) may be a downlink logical channel for carrying a Paging message.

A Common Control Channel (CCCH) may be a logical channel for transmitting control information between the terminal apparatus and the base station apparatus. The CCCH may be used in a case that the terminal apparatus does not have RRC connection. The CCCH may be used between the base station apparatus and multiple terminal apparatuses.

A Dedicated Control Channel (DCCH) may be a logical channel for transmitting dedicated control information in a point-to-point bi-directional manner between the terminal apparatus and the base station apparatus. The dedicated control information may be control information dedicated to each terminal apparatus. The DCCH may be used in a case that the terminal apparatus has RRC connection.

A Dedicated Traffic Channel (DTCH) may be a logical channel for transmitting user data in a point-to-point manner between the terminal apparatus and the base station apparatus. The DTCH may be a logical channel for transmitting dedicated user data. The dedicated user data may be user data dedicated to each terminal apparatus. The DTCH may be present in both of the uplink and the downlink.

A Multicast Traffic Channel (MTCH) may be a point-to-multipoint downlink channel for transmitting data from the base station apparatus to the terminal apparatus. The MTCH may be a logical channel for multicasting. The MTCH may be used by the terminal apparatus only in a case that the terminal apparatus receives MBMS.

A Multicast Control Channel (MCCH) may be a point-to-multipoint downlink channel for transmitting MBMS control information for one or multiple MTCHs from the base station apparatus to the terminal apparatus. The MCCH may be a logical channel for multicasting. The MCCH may be used by the terminal apparatus only in a case that the terminal apparatus receives MBMS or the terminal apparatus is interested in receiving MBMS.

A Single Cell Multicast Traffic Channel (SC-MTCH) may be a point-to-multipoint downlink channel for transmitting data by using SC-PTM from the base station apparatus to the terminal apparatus. The SC-MTCH may be a logical channel for multicasting. The SC-MTCH may be used by the terminal apparatus only in a case that the terminal apparatus receives MBMS by using Single Cell Point-To-Multipoint (SC-PTM).

A Single Cell Multicast Control Channel (SC-MCCH) may be a point-to-multipoint downlink channel for transmitting MBMS control information for one or multiple SC-MTCHs from the base station apparatus to the terminal apparatus. The SC-MCCH may be a logical channel for multicasting. The SC-MCCH may be used by the terminal apparatus only in a case that the terminal apparatus receives MBMS by using SC-PTM or the terminal apparatus is interested in receiving MBMS by using SC-PTM.

Mapping between the logical channels and the transport channels in uplink, in E-UTRA and/or NR will be described.

The CCCH may be mapped to an Uplink Shared Channel (UL-SCH) being an uplink transport channel.

The DCCH may be mapped to an Uplink Shared Channel (UL-SCH) being an uplink transport channel.

The DTCH may be mapped to an Uplink Shared Channel (UL-SCH) being an uplink transport channel.

Mapping between the logical channels and the transport channels in downlink, in E-UTRA and/or NR will be described.

The BCCH may be mapped to a Broadcast Channel (BCH) and/or a Downlink Shared Channel (DL-SCH) being a downlink transport channel.

The PCCH may be mapped to a Paging Channel (PCH) being a downlink transport channel.

The CCCH may be mapped to a Downlink Shared Channel (DL-SCH) being a downlink transport channel.

The DCCH may be mapped to a Downlink Shared Channel (DL-SCH) being a downlink transport channel.

The DTCH may be mapped to a Downlink Shared Channel (DL-SCH) being a downlink transport channel.

The MTCH may be mapped to a Multicast Channel (MCH) being a downlink transport channel.

The MCCH may be mapped to a Multicast Channel (MCH) being a downlink transport channel.

The SC-MTCH may be mapped to a Downlink Shared Channel (DL-SCH) being a downlink transport channel.

The SC-MTCH may be mapped to a Downlink Shared Channel (DL-SCH) being a downlink transport channel.

An example of the functions of the RLC will be described. The RLC may be referred to as an RLC sublayer. The E-UTRA RLC may have a function of segmenting (Segmentation) and/or concatenating (Concatenation) data provided from the PDCP of an upper layer, and providing the segmented and/or concatenated data to a lower layer. The E-UTRA RLC may have a function of reassembling (reassembly) and re-ordering data provided from a lower layer, and providing the reassembled and re-ordered data to an upper layer. The NR RLC may have a function of assigning data provided from the PDCP of an upper layer with a sequence number independent of a sequence number assigned in the PDCP. The NR RLC may have a function of segmenting (Segmentation) data provided from the PDCP, and providing the segmented data to a lower layer. The NR RLC may have a function of reassembling (reassembly) data provided from a lower layer, and providing the reassembled data to an upper layer. The RLC may have a data retransmission function and/or retransmission request function (Automatic Repeat reQuest (ARQ)). The RLC may have a function of performing error correction using the ARQ. Control information that indicates data required to be retransmitted and that is transmitted from a receiving side to a transmitting side of the RLC in order to perform the ARQ may be referred to as a status report. A status report transmission indication transmitted from the transmitting side to the receiving side of the RLC may be referred to as a poll. The RLC may have a function of detecting data duplication. The RLC may have a function of discarding data. The RLC may have three modes, namely a Transparent Mode (TM), an Unacknowledged Mode (UM), and an Acknowledged Mode (AM). In the TM, segmentation of data received from an upper layer may not be performed, and addition of an RLC header may not be performed. A TM RLC entity may be a uni-directional entity, and may be configured as a transmitting TM RLC entity or as a receiving TM RLC entity. In the UM, segmentation and/or concatenation of data received from an upper layer, addition of an RLC header, and the like may be performed, but retransmission control of data may not be performed. A UM RLC entity may be a uni-directional entity, or may be a bi-directional entity. In a case that the UM RLC entity is a uni-directional entity, the UM RLC entity may be configured as a transmitting UM RLC entity or as a receiving UM RLC entity. In a case that the UM RLC entity is a bi-directional entity, the UM RRC entity may be configured as a UM RLC entity constituted with a transmitting side and a receiving side. In the AM, segmentation and/or concatenation of data received from an upper layer, addition of an RLC header, retransmission control of data, and the like may be performed. An AM RLC entity may be a bi-directional entity, and may be configured as an AM RLC constituted with a transmitting side and a receiving side. Note that data provided to a lower layer and/or data provided from a lower layer in the TM may be referred to as a TMD PDU. Data provided to a lower layer and/or data provided from a lower layer in the UM may be referred to as a UMD PDU. Data provided to a lower layer or data provided from a lower layer in the AM may be referred to as an AMD PDU. An RLC PDU format used in the E-UTRA RLC and an RLC PDU format used in the NR RLC may be different from each other. The RLC PDU may include an RLC PDU for data and an RLC PDU for control. The RLC PDU for data may be referred to as an RLC DATA PDU (RLC Data PDU, RLC data PDU). The RLC PDU for control may be referred to as an RLC CONTROL PDU (RLC Control PDU, RLC control PDU).

An example of the functions of the PDCP will be described. The PDCP may be referred to as a PDCP sublayer. The PDCP may have a function of maintenance of the sequence number. The PDCP may have a header compression and decompression function for efficiently transmitting, in wireless sections, user data such as an IP Packet and an Ethernet frame. A protocol used for header compression and decompression for an IP packet may be referred to as a Robust Header Compression (ROHC) protocol. A protocol used for header compression and decompression for an Ethernet frame may be referred to as an Ethernet (trade name) Header Compression (EHC) protocol. The PDCP may have a function of ciphering and deciphering of data. The PDCP may have a function of integrity protection and integrity verification of data. The PDCP may have a function of re-ordering. The PDCP may have a function of retransmitting the PDCP SDU. The PDCP may have a function of discarding data using a discard timer. The PDCP may have a Duplication function. The PDCP may have a function of discarding pieces of data received in a duplicate manner. The PDCP entity may be a bi-directional entity, and may include a transmitting PDCP entity and a receiving PDCP entity. A PDCP PDU format used in the E-UTRA PDCP and a PDCP PDU format used in the NR PDCP may be different from each other. The PDCP PDU may include a PDCP PDU for data and a PDCP PDU for control. The PDCP PDU for data may be referred to as a PDCP DATA PDU (PDCP Data PDU, PDCP data PDU). The PDCP PDU for control may be referred to as a PDCP CONTROL PDU (PDCP Control PDU, PDCP control PDU).

In the PDCP, in a case of performing processing of ciphering or integrity protection, a COUNT value may be used. The COUNT value may include a Hyper Frame Number (HFN) being a state variable of the PDCP, and a Sequence Number (SN) added to the header of the PDCP PDU. The sequence number may be incremented by 1 every time the PDCP DATA PDU is generated in a transmitting PDCP entity. The HFN may be incremented by 1 every time the sequence number reaches a maximum value in the transmitting PDCP entity and a receiving PDCP entity. In order to manage the COUNT value in the transmitting PDCP entity and the receiving PDCP entity, a part or all of the following state variables of (A) to (F) may be used.
(A) a state variable indicating the COUNT value of the PDCP SDU to be transmitted next. The state variable may be a state variable referred to as TX_NEXT;
(B) a state variable indicating the sequence number of the PDCP SDU to be transmitted next, in the PDCP entity. The state variable may be a state variable referred to as Next_PDCP_TX_SN;
(C) a state variable indicating an HFN value used for generating the COUNT value of the PDCP PDU in the PDCP entity. The state variable may be a state variable referred to as TX_HFN;
(D) a state variable indicating the COUNT value of the PDCP SDU expected to be received next in the receiving PDCP entity. The state variable may be a state variable referred to as RX_NEXT;
(E) a state variable indicating the sequence number of the PDCP SDU expected to be received next in the receiving PDCP entity. The state variable may be a state variable referred to as Next_PDCP_RX_SN;
(F) a state variable indicating an HFN value used for generating the COUNT value for a received PDCP PDU in the PDCP entity. The state variable may be a state variable referred to as RX_HFN.

In the PDCP, re-ordering may be processing for storing the PDCP SDUs in a receive buffer (re-ordering buffer) and delivering the PDCP SDUs to an upper layer according to the order of the COUNT values obtained from header information of the PDCP DATA PDUs. In re-ordering. in a case that the COUNT value of the PDCP Data PDU received is the COUNT value of a first PDCP SDU not delivered to the upper layer yet, processing for delivering the stored PDCP SDUs to the upper layer according to the order of COUNT values may be performed. In other words, in a case that the PDCP data PDUs having the COUNT values smaller than the COUNT values of the received PDCP data PDUs have not yet been successfully received (PDCP data PDUs are lost), the processing may be performed in which the received PDCP data PDUs are converted into the PDCP SDUs, the PDCP SDUs are stored in the re-ordering buffer, all of the lost PDCP data PDUs are received and converted into the PDCP SDUs, and then the PDCP SDUs are delivered to the upper layer. In re-ordering, in order to detect loss of the PDCP data PDUs, a re-ordering timer (a timer referred to as t-Reordering) may be used. For re-ordering, a part or all of the following state variables of (A) to (F) may be used:
(A) a state variable indicating the COUNT value of the PDCP SDU expected to be received next in the receiving PDCP entity. The state variable may be a state variable referred to as RX_NEXT;
(B) a state variable indicating the sequence number of the PDCP SDU expected to be received next in the receiving PDCP entity. The state variable may be a state variable referred to as Next_PDCP_RX_SN;
(C) a state variable indicating an HFN value used for generating the COUNT value for a received PDCP PDU in the PDCP entity. The state variable may be a state variable referred to as RX_HFN;
(D) a state variable indicating the COUNT value of a first PDCP PDU out of PDCP SDUs that are to be received and have not been delivered to an upper layer in the receiving PDCP entity. The state variable may be a state variable referred to as RX_DELIV;
(E) a state variable indicating the sequence number of the PDCP PDU out of the PDCP SDUs that were last delivered to an upper layer in the receiving PDCP entity. The state variable may be a state variable referred to as Last_Submitted_PDCP_RX_SN;
(F) a state variable indicating a COUNT value next to the COUNT value of the PDCP PDU that caused the re-ordering timer to start in the receiving PDCP entity. The state variable may be a state variable referred to as RX_REORD, or may be a state variable referred to as Reordering_PDCP_RX_COUNT.

Status Reporting in the PDCP will be described. In a DRB (Acknowledged Mode Data Radio Bearer (AM DRB)) using RLC of an Acknowledged Mode in which transmission of a PDCP status report is configured by an upper layer, the receiving PDCP entity may trigger the PDCP status report in a case that one condition of the following (A) to (D) is satisfied. In a DRB (Unacknowledged Mode Data Radio Bearer (UM DRB)) using RLC of an Unacknowledged Mode in which transmission of a PDCP status report is configured by an upper layer, the receiving PDCP entity may trigger the PDCP status report in a case that the condition of the following (C) is satisfied. (A) to (D) are as follows:
(A) the upper layer requests re-establishment of the PDCP entity;
(B) the upper layer requests PDCP data recovery;
(C) the upper layer requests uplink data switching;
(D) the upper layer reconfigures the PDCP entity in order to release a Dual Active Protocol Stack (DAPS), and a parameter referred to as daps source release is configured.

In a case that transmission of the PDCP status report is triggered, the receiving PDCP entity may perform creation of the PDCP status report. The creation of the PDCP status report may be performed by storing, in the PDCP control PDU for the PDCP status report, information of the PDCP SDUs to be received including the COUNT value of the first PDCP PDU out of the PDCP SDUs that are to be received and have not been delivered to the upper layer. The receiving PDCP entity that has created the PDCP status report may submit the created PDCP status report to a lower layer via the transmitting PDCP entity.

Note that, in an embodiment of the present invention, the PDCP entity of the UM DRB in which transmission of the PDCP status report is configured by the upper layer may determine that PDCP data recovery has been requested from the upper layer. The PDCP entity of the UM DRB that has determined that PDCP data recovery has been requested from the upper layer may create the PDCP status report in the receiving PDCP entity, based on that the PDCP data recovery has been requested from the upper layer, and submit the created PDCP status report to a lower layer via the transmitting PDCP entity. Note that the lower layer may be a UM RLC entity of an RLC bearer associated with the PDCP entity. Note that, in an embodiment of the present invention, only in a case that the UM DRB is not a DAPS bearer, the PDCP entity of the UM DRB in which transmission of the PDCP status report is configured by the upper layer may determine that PDCP data recovery has been requested from the upper layer. The DAPS bearer may be a bearer in which one or multiple RLC entities for a source cell and one or multiple RLC entities for a target cell are associated with the PDCP entity. As the PDCP data recovery, another term indicating that the upper layer requests the PDCP to transmit the status report may be used.

The ROHC will be described. In an embodiment of the present invention, the ROHC may be referred to as an ROHC protocol. The ROHC may have a function of compressing header information, such as an IP, a UDP, a TCP, and an RTP, and a function of decompressing the header information. In the ROHC, a compressor may have a header compression function of compressing the header information. In the ROHC, a decompressor may have a header decompression function of decompressing the header information. The compressor may perform header compression by using a context stored in the compressor. The decompressor may perform header decompression by using a context stored in the decompressor. In an embodiment of the present invention, the context may be referred to as an ROHC context. The context in the decompressor may be generated by receiving all of the pieces of header information from the compressor. The context in the compressor and the decompressor may be stored for each IP flow. In order to identify the context, a Context Identifier (CID) may be used. Information of a maximum value of the context identifier, information of a profile indicating a method of header compression and decompression, and the like may be negotiated between the compressor and the decompressor before the header compression and decompression is performed.

In the ROHC, the header information may be classified into static parts and dynamic parts. The static parts of the header information in the ROHC may be information that hardly changes out of the header information of each packet belonging to the IP flow. The static parts of the header information in the ROHC may be, for example, information including a source address, a destination address, and a version in an IPv4 header and an IPv6 header, a source port and a destination port in a UDP header and a TCP header, and the like. The dynamic parts of the header information in the ROHC may be information that may change for each packet out of the header information of each packet belonging to the IP flow. The dynamic parts of the header information in the ROHC may be, for example, information including a traffic class and a hop limit in the IPv6 header, Type of service and Time to Live in the IPv4 header, a checksum in the UDP header, an RTP sequence number and an RTP timestamp in the RTP header, and the like.

The compressor of the ROHC may have three states, i.e., an Initialization and Refresh (IR) state, a First Order (FO) state, and a Second Order (SO) state. In a case that the IR state is used, the compressor may transmit all of the pieces of header information to the decompressor, without compressing pieces of header information to be compressed. In a case that the FO state is used, the compressor may perform transmission to the decompressor, by compressing a most part of the static parts and without compressing a part of the static parts and the dynamic parts, out of the pieces of header information to be compressed. In a case that the SO state is used, a compression rate of the header is the highest, and the compressor may only transmit limited information, such as the RTP sequence number.

The decompressor of the ROHC may have three states, i.e., a No Context (NC) state, a Static Context (SC) state, and a Full Context (FC) state. An initial state of the decompressor may be the NC state. In a case that the context is acquired in the NC state, and the state then transitions to a state in which header decompression is performed correctly, the state may transition to the FC state. In a case that header decompression continuously fails in the FC state, the state may transition to the SC state or the NC state.

Processing modes of the ROHC may have three modes, i.e., a Unidirectional mode (U-mode), a Bidirectional Optimistic mode (O-mode), and a Bidirectional Reliable mode (R-mode). In the U-mode, an ROHC feedback packet need not be used. In the U-mode, transition from a low compression mode to a high compression mode, i.e., transition from the IR state to the FO state, and/or transition from the FO state to the SO state, and/or transition from the IR state to the SO state in the compressor may be performed by transmitting a certain number of packets. In the U-mode, transition from a high compression mode to a low compression mode, i.e., transition from the SO state to the FO state, and/or transition from the FO state to the IR state, and/or transition from the SO state to the IR state in the compressor may be performed periodically, such that information necessary for header decompression may be periodically transmitted to the decompressor. In the O-mode, the decompressor may transmit an ROHC feedback packet to the compressor, and thereby perform a context update request to the compressor. In the R-mode, the compressor may receive a header decompression succeed notification on an ROHC feedback packet from the decompressor, and thereby transition from a low compression mode to a high compression mode. In the R-mode, the compressor may receive a context update request on an ROHC feedback packet from the decompressor, and thereby transition from a high compression mode to a low compression mode. The processing mode of the ROHC may start with the U-mode. Transition of the processing mode of the ROHC may be determined by the decompressor.

The decompressor may prompt the compressor to transition the processing mode by using an ROHC feedback packet.

An example of the functions of the SDAP will be described. The SDAP is a service data adaptation protocol layer. The SDAP may have a function of performing association (mapping) between a downlink QoS flow transmitted from the 5GC 110 to the terminal apparatus via the base station apparatus and a data radio bearer (DRB) and/or mapping between an uplink QoS flow transmitted from the terminal apparatus to the 5GC 110 via the base station apparatus and a DRB. The SDAP may have a function of storing mapping rule information. The SDAP may have a function of performing marking of a QoS flow identifier (QoS Flow ID (QFI)). Note that the SDAP PDU may include an SDAP PDU for data and an SDAP PDU for control. The SDAP PDU for data may be referred to as an SDAP DATA PDU (SDAP Data PDU, SDAP data PDU). The SDAP PDU for control may be referred to as an SDAP CONTROL PDU (SDAP Control PDU, SDAP control PDU). Note that, in the terminal apparatus, one SDAP entity may be present for one PDU session.

An example of the functions of the RRC will be described. The RRC may have a broadcast function. The RRC may have a Paging function from the EPC 104 and/or the 5GC 110. The RRC may have a Paging function from the gNB 108 or the eNB 102 connected to the 5GC 100. The RRC may have an RRC connection management function. The RRC may have a radio bearer control function. The RRC may have a cell group control function. The RRC may have a mobility control function. The RRC may have a terminal apparatus measurement reporting and terminal apparatus measurement reporting control function. The RRC may have a QoS management function. The RRC may have a radio link failure detection and recovery function. With use of an RRC message, the RRC may perform broadcast, paging, RRC connection management, radio bearer control, cell group control, mobity control, terminal apparatus measurement reporting and terminal apparatus measurement reporting control, QoS management, radio link failure detection and recovery, and the like. Note that RRC messages and parameters used in the E-UTRA RRC may be different from RRC messages and parameters used in the NR RRC.

The RRC message may be transmitted using the BCCH of the logical channel, may be transmitted using the PCCH of the logical channel, may be transmitted using the CCCH of the logical channel, may be transmitted using the DCCH of the logical channel, or may be transmitted using the MCCH of the logical channel.

In the RRC message transmitted using the BCCH, for example, a Master Information Block (MIB) may be included, a System Information Block (SIB) of each type may be included, or another RRC message may be included. In the RRC message transmitted using the PCCH, for example, a paging message may be included, or another RRC message may be included.

In the RRC message transmitted in the uplink (UL) direction using the CCCH, for example, an RRC setup request message (RRC Setup Request), an RRC resume request message (RRC Resume Request), an RRC reestablishment request message (RRC Reestablishment Request), an RRC system information request message (RRC System Info Request), and the like may be included. For example, an RRC connection request message (RRC Connection Request), an RRC connection resume request message (RRC Connection Resume Request), an RRC connection reestablishment request message (RRC Connection Reestablishment Request), and the like may be included. Another RRC message may be included.

In the RRC message transmitted in the downlink (DL) direction using the CCCH, for example, an RRC connection reject message (RRC Connection Reject), an RRC connection setup message (RRC Connection Setup), an RRC connection reestablishment message (RRC Connection Reestablishment), an RRC connection reestablishment reject message (RRC Connection Reestablishment Reject), and the like may be included. For example, an RRC reject message (RRC Reject), an RRC setup message (RRC Setup), an RRC resume message (RRC Resume), and the like may be included. Another RRC message may be included.

In the RRC message transmitted in the uplink (UL) direction using the DCCH, for example, a measurement report message (Measurement Report), an RRC connection reconfiguration complete message (RRC Connection Reconfiguration Complete), an RRC connection setup complete message (RRC Connection Setup Complete), an RRC connection reestablishment complete message (RRC Connection Reestablishment Complete), a security mode complete message (Security Mode Complete), a UE capability information message (UE Capability Information), and the like may be included. For example, a measurement report message (Measurement Report), an RRC reconfiguration complete message (RRC Reconfiguration Complete), an RRC setup complete message (RRC Setup Complete), an RRC reestablishment complete message (RRC Reestablishment Complete), an RRC resume complete message (RRC Resume Complete), a security mode complete message (Security Mode Complete), a UE capability information message (UE Capability Information), a counter check response message (Counter Check Response), and the like may be included. Another RRC message may be included.

In the RRC message transmitted in the downlink (DL) direction using the DCCH, for example, an RRC connection reconfiguration message (RRC Connection Reconfiguration), an RRC connection release message (RRC Connection Release), a security mode command message (Security Mode Command), a UE capability enquiry message (UE Capability Enquiry), and the like may be included. For example, an RRC reconfiguration message (RRC Reconfiguration), an RRC resume message (RRC Resume), an RRC release message (RRC Release), an RRC reestablishment message (RRC Reestablishment), a security mode command message (Security Mode Command), a UE capability enquiry message (UE Capability Enquiry), a counter check message (Counter Check), and the like may be included. Another RRC message may be included.

An example of the functions of the NAS will be described. The NAS may have an authentication function. The NAS may have a function of performing mobility management. The NAS may have a function of security control.

The functions of the PHY, the MAC, the RLC, the PDCP, the SDAP, the RRC, and the NAS described above are merely an example, and a part or all of each of the functions may not be implemented. Some or all of the functions of each layer may be included in another layer.

Note that, in upper layers (not illustrated) of the AS layer of the terminal apparatus, an IP layer, and a Transmission Control Protocol (TCP) layer and a User Datagram Protocol (UDP) layer, which are upper layers of the IP layer, and the like may be present. In the upper layers of the AS layer of the terminal apparatus, an Ethernet layer may be present. This may be referred to as a PDU layer being an upper layer of the AS layer of the terminal apparatus. The PDU layer may include the IP layer, the TCP layer, the UDP layer, the Ethernet layer, and the like. In the upper layers of the IP layer, the TCP layer, the UDP layer, the Ethernet layer, and the PDU layer, an application layer may be present. The application layer may include a Session Initiation Protocol (SIP) and a Session Description Protocol (SDP) used in an IP Multimedia Subsystem (IMS) being one of service networks standardized in 3GPP. The application layer may include protocols, such as a Real-time Transport Protocol (RTP) used for media communication and/or Real-time Transport Control Protocol (RTCP) for media communication control, and/or a HyperText Transfer Protocol (HTTP). The application layer may include a codec for various media and the like. The RRC layer may be an upper layer of the SDAP layer.

The state transition of the UE 122 in LTE and NR will now be described. Regarding the UE 122 connected to the EPC or the 5GC, the UE 122 may be in an RRC_CONNECTED state in a case that an RRC connection has been established. The state in which the RRC connection has been established may include a state in which the UE 122 retains a part or all of UE contexts to be described below. The state in which the RRC connection has been established may include a state in which the UE 122 can transmit and/or receive unicast data. Regarding the UE 122, in a case that the RRC connection is suspended, the UE 122 may be in an RRC_INACTIVE state. The case that the UE 122 is in the RRC_INACTIVE state may be a case that the UE 122 is connected to the 5GC and the RRC connection is suspended. In a case that the UE 122 is in neither the RRC_CONNECTED state nor the RRC_INACTIVE state, the UE 122 may be in an RRC_IDLE state.

Note that, in a case that the UE 122 is connected to the EPC, suspension of the RRC connection may be started by the E-UTRAN although the UE 122 does not have the RRC_INACTIVE state. In a case that the UE 122 is connected to the EPC and the RRC connection is suspended, the UE 122 may transition to the RRC_IDLE state while retaining an AS context of the UE and an identifier (resume Identity) used for resumption (resume). In a case that the UE 122 retains the AS context of the UE and that the E-UTRAN permits the RRC connection to be resumed and that the UE 122 needs to transition from the RRC_IDLE state to the RRC_CONNECTED state, an upper layer (for example, the NAS layer) of the RRC layer of the UE 122 may initiate the resumption of the RRC connection suspended.

The definition of the suspension may vary between the UE 122 connected to the EPC 104 and the UE 122 connected to the 5GC 110. All or a part of the procedures for the UE 122 to resume from suspension may be different between a case that the UE 122 is connected to the EPC (is suspended in the RRC_IDLE state) and a case that the UE 122 is connected to the 5GC (is suspended in the RRC_INACTIVE state).

Note that the RRC_CONNECTED state, the RRC_NACTIVE state, and the RRC_IDLE state may be respectively referred to as a connected state (connected mode), an inactive state (inactive mode), and an idle state (idle mode), or may be respectively referred to as an RRC connected state (RRC connected mode), an RRC inactive state (RRC inactive mode), and an RRC idle state (RRC idle mode).

The AS context of the UE retained by the UE 122 may be information including all or some of a current RRC configuration, a current security context, a PDCP state including a RObust Header Compression (ROHC) state, a Cell Radio Network Temporary Identifier (C-RNTI) used in a PCell of a connection source, a cell identity (cell Identity), and a physical cell identity of the PCell of the connection source. Note that the AS context of the UE retained by one or all of the eNB 102 and the gNB 108 may include information identical to the information of the AS context of the UE retained by the UE 122, or may include information different from the information included in the AS context of the UE retained by the UE 122.

The security context may be information including all or some of a ciphering key at the AS level, a Next Hop parameter (NH), a Next Hop Chaining Counter parameter (NCC) used to derive an access key for the next hop, an identifier of a ciphering algorithm at a selected AS level, and a counter used for replay protection.

The Cell Group configured for the terminal apparatus from the base station apparatus will be described. The cell group may include one Special Cell (SpCell). The cell group may include one SpCell and one or multiple Secondary Cells (SCells). In other words, the cell group may include one SpCell, and optionally one or multiple SCells. Note that, in a case that the MAC entity is associated with a Master Cell Group (MCG), the SpCell may mean a Primary Cell (PCell). In a case that the MAC entity is associated with a Secondary Cell Group (SCG), the SpCell may mean a Primary SCG Cell (PSCell). In a case that the MAC entity is not associated with the cell group, the SpCell may mean the PCell. The PCell, the PSCell, and the SCell are each a serving cell. The SpCell may support PUCCH transmission and contention-based Random Access, and the SpCell may be constantly activated. The PCell may be a cell used for an RRC connection establishment procedure in a case that the terminal apparatus in the RRC idle state transitions to the RRC connected state. The PCell may be a cell used for an RRC connection reestablishment procedure in which the terminal apparatus performs reestablishment of RRC connection. The PCell may be a cell used for a random access procedure in a case of a handover. The PSCell may be a cell used for the random access procedure in a case of addition of a Secondary Node (SN) to be described below. The SpCell may be a cell used for purposes other than the purposes described above. Note that, in a case that the cell group includes the SpCell and one or more SCells, it can be said that carrier aggregation (CA) is configured for the cell group. For the terminal apparatus configured with CA, a cell that provides additional radio resources to the SpCell may mean the SCell.

A group of serving cells configured by the RRC, which is a cell group using the same timing reference cell and the same timing advance value for cells out of the group configured with the uplink may be referred to as a Timing Advance Group (TAG). The TAG including the SpCell of the MAC entity may mean a Primary Timing Advance Group (PTAG). The TAG other than the PTAG may mean a Secondary Timing Advance Group (STAG).

In a case that Dual Connectivity (DC) and Multi-Radio Dual Connectivity (MR-DC) are performed, addition of a cell group for the terminal apparatus from the base station apparatus may be performed. DC may be a technology for performing data communication by using radio resources of the cell groups configured by each of a first base station apparatus (first node) and a second base station apparatus (second node). MR-DC may be a technology included in DC. In order to perform DC, the first base station apparatus may add the second base station apparatus. The first base station apparatus may be referred to as a Master Node (MN). The cell group configured by the master node may be referred to as a Master Cell Group (MCG). The second base station apparatus may be referred to as a Secondary Node (SN). The cell group configured by the secondary node may be referred to as a Secondary Cell Group (SCG). Note that the master node and the secondary node may be configured in the same base station apparatus.

In a case that DC is not configured, the cell group configured for the terminal apparatus may be referred to as an MCG. In the case that DC is not configured, the SpCell configured for the terminal apparatus may be the PCell.

Note that MR-DC may be a technology for performing DC using E-UTRA for the MCG and NR for the SCG. MR-DC may be a technology for performing DC using NR for the MCG and E-UTRA for the SCG. MR-DC may be a technology for performing DC using NR for both of the MCG and the SCG. As an example of MR-DC using E-UTRA for the MCG and NR for the SCG, there may be E-UTRA-NR Dual Connectivity (EN-DC) using the EPC as a core network, or there may be NG-RAN E-UTRA-NR Dual Connectivity (NGEN-DC) using the 5GC as a core network. As an example of MR-DC using NR for the MCG and E-UTRA for the SCG, there may be NR-E-UTRA Dual Connectivity (NE-DC) using the 5GC as a core network. As an example of MR-DC using NR for both of the MCG and the SCG, there may be NR-NR Dual Connectivity (NR-DC) using the 5GC as a core network.

Note that, in the terminal apparatus, one MAC entity may be present for each cell group. For example, in a case that DC or MR-DC is configured for the terminal apparatus, one MAC entity may be present for the MCG, and one MAC entity may be present for the SCG. The MAC entity for the MCG in the terminal apparatus may be constantly established for the terminal apparatus in all of the states (the RRC idle state, the RRC connected state, the RRC inactive state, and the like). The MAC entity for the SCG in the terminal apparatus may be created by the terminal apparatus in a case that the SCG is configured for the terminal apparatus. Configuration of the MAC entity for each cell group of the terminal apparatus may be performed in a case that the terminal apparatus receives an RRC message from the base station apparatus. In EN-DC and NGEN-DC, the MAC entity for the MCG may be an E-UTRA MAC entity, and the MAC entity for the SCG may be an NR MAC entity. In NE-DC, the MAC entity for the MCG may be an NR MAC entity, and the MAC entity for the SCG may be an E-UTRA MAC entity. In NR-DC, the MAC entities for the MCG and the SCG may each be an NR MAC entity. Note that a case that one MAC entity is present for each cell group may be alternatively described as a case that one MAC entity is present for each SpCell. One MAC entity for each cell group may be alternatively referred to as one MAC entity for each SpCell.

The radio bearers will be described. For the SRBs of E-UTRA, SRB0 to SRB2 may be defined, or SRBs other than these may be defined. For the SRBs of NR, SRB0 to SRB3 may be defined, or SRBs other than these may be defined. SRB0 may be an SRB for an RRC message transmitted and/or received using the CCCH of the logical channel. SRB1 may be an SRB for an RRC message, and for a NAS message before establishment of SRB2. The RRC message transmitted and/or received using SRB1 may include a piggybacked NAS message. For all of RRC messages and NAS messages transmitted and/or received using SRB1, the DCCH of the logical channel may be used. SRB2 may be an SRB for a NAS message, and for an RRC message including logged measurement information. For all of RRC messages and NAS messages transmitted and/or received using SRB2, the DCCH of the logical channel may be used. SRB2 may have a priority lower than that of SRB1. SRB3 may be an SRB for transmitting and/or receiving a specific RRC message in a case that EN-DC, NGEN-DC, NR-DC, or the like is configured for the terminal apparatus. For all of RRC messages and NAS messages transmitted and/or received using SRB3, the DCCH of the logical channel may be used. Other SRBs may be provided for other purposes. The DRB may be a radio bearer for user data. For an RRC message transmitted and/or received using the DRB, the DTCH of the logical channel may be used.

The radio bearers in the terminal apparatus will be described. The radio bearers include an RLC bearer. The RLC bearer may include one or two RLC entities and a logical channel. The RLC entities in a case that the RLC bearer includes two RLC entities may be the transmitting RLC entity and the receiving RLC entity in the TM RLC entity and/or the uni-directional UM mode RLC entity. SRB0 may include one RLC bearer. The RLC bearer of SRB0 may include the RLC entity of TM, and a logical channel. SRB0 may be constantly established in the terminal apparatus in all of the states (the RRC idle state, the RRC connected state, the RRC inactive state, and the like). In a case that the terminal apparatus transitions from the RRC idle state to the RRC connected state, one SRB1 may be established and/or configured for the terminal apparatus, using an RRC message received from the base station apparatus. SRB1 may include one PDCP entity, and one or multiple RLC bearers. The RLC bearer of SRB1 may include the RLC entity of AM, and a logical channel. One SRB2 may be established and/or configured for the terminal apparatus, using an RRC message that the terminal apparatus in the RRC connected state with activated AS security receives from the base station apparatus. SRB2 may include one PDCP entity, and one or multiple RLC bearers. The RLC bearer of SRB2 may include the RLC entity of AM, and a logical channel. Note that the PDCP of SRB1 and SRB2 on the base station apparatus side may be deployed in the master node. In a case that the secondary node in EN-DC, NGEN-DC, or NR-DC is added or in a case that the secondary node is changed, one SRB3 may be established and/or configured for the terminal apparatus, using an RRC message that the terminal apparatus in the RRC connected state with activated AS security receives from the base station apparatus. SRB3 may be a direct SRB between the terminal apparatus and the secondary node. SRB3 may include one PDCP entity, and one or multiple RLC bearers. The RLC bearer of SRB3 may include the RLC entity of AM, and a logical channel. The PDCP of the SRB3 on the base station apparatus side may be deployed in the secondary node. One or multiple DRBs may be established and/or configured for the terminal apparatus, using an RRC message that the terminal apparatus in the RRC connected state with activated AS security receives from the base station apparatus. The DRB may include one PDCP entity, and one or multiple RLC bearers. The RLC bearer of the DRB may include the RLC entity of AM or UM, and a logical channel.

Note that, in MR-DC, the radio bearer whose PDCP is deployed in the master node may be referred to as an MN terminated bearer. In MR-DC, the radio bearer whose PDCP is deployed in the secondary node may be referred to as an SN terminated bearer. Note that, in MR-DC, the radio bearer whose RLC bearer is present only in the MCG may be referred to as an MCG bearer. In MR-DC, the radio bearer whose RLC bearer is present only in the SCG may be referred to as an SCG bearer. In DC, the radio bearer whose RLC bearer is present in both of the MCG and the SCG may be referred to as a split bearer.

In a case that MR-DC is configured for the terminal apparatus, a bearer type of SRB1 and SRB2 established/and or configured for the terminal apparatus may be an MN terminated MCG bearer and/or an MN terminated split bearer. In a case that MR-DC is configured for the terminal apparatus, a bearer type of SRB3 established/and or configured for the terminal apparatus may be an SN terminated SCG bearer. In a case that MR-DC is configured for the terminal apparatus, a bearer type of the DRB established/and or configured for the terminal apparatus may be any one of all of the bearer types.

The RLC entity established and/or configured for the RLC bearer established and/or configured for the cell group configured in E-UTRA may be the E-UTRA RLC. The RLC entity established and/or configured for the RLC bearer established and/or configured for the cell group configured in NR may be the NR RLC. In a case that EN-DC is configured for the terminal apparatus, the PDCP entity established and/or configured for the MN terminated MCG bearer may be either the E-UTRA PDCP or the NR PDCP. In a case that EN-DC is configured for the terminal apparatus, the PDCP established and/or configured for the radio bearers of other bearer types, i.e., an MN terminated split bearer, an MN terminated SCG bearer, an SN terminated MCG bearer, an SN terminated split bearer, and an SN terminated SCG bearer, may be the NR PDCP. In a case that NGEN-DC, NE-DC, or NR-DC is configured for the terminal apparatus, the PDCP entity established and/or configured for the radio bearers of all of the bearer types may be the NR PDCP.

Note that, in NR, the DRB established and/or configured for the terminal apparatus may be associated with one PDU session. One SDAP entity may be established and/or configured for one PDU session in the terminal apparatus. The SDAP entity, the PDCP entity, the RLC entity, and the logical channel established and/or configured for the terminal apparatus may be established and/or configured using an RRC message that the terminal apparatus receives from the base station apparatus.

Note that, regardless of whether or not MR-DC is configured, a network configuration in which the master node is the eNB 102 and the EPC 104 is used as a core network may be referred to as E-UTRA/EPC. A network configuration in which the master node is the eNB 102 and the 5GC 110 is used as a core network may be referred to as E-UTRA/5GC. A network configuration in which the master node is the gNB 108 and the 5GC 110 is used as a core network may be referred to as NR or NR/5GC. In a case that MR-DC is not configured, the master node described above may refer to the base station apparatus that performs communication with the terminal apparatus.

Next, the handover in LTE and NR will be described. The handover may be processing in which the UE 122 in the RRC connected state changes the serving cell. The handover may be performed in a case that the UE 122 receives an RRC message indicating handover from the eNB 102 and/or the gNB 108. The RRC message indicating handover may be a message related to reconfiguration of RRC connection including a parameter indicating handover (for example, an information element referred to as MobilityControlInfo, or an information element referred to as ReconfigurationWithSync). Note that the information element referred to as MobilityControlInfo described above may be alternatively referred to as a mobility control configuration information element, a mobility control configuration, or mobility control information. Note that the information element referred to as ReconfigurationWithSync described above may be alternatively referred to as a reconfiguration with synchronization information element, or a reconfiguration with synchronization. Alternatively, the RRC message indicating handover may be a message (for example, MobilityFromEUTRACommand, or MobilityFromNRCommand) indicating movement to a cell of another RAT. The handover may be alternatively referred to as a reconfiguration with synchronization (reconfiguration with sync). As a condition that the UE 122 can perform handover, a case that a part or all of a case that AS security is activated, a case that the SRB2 has been established, included may be that at least one DRB has been established.

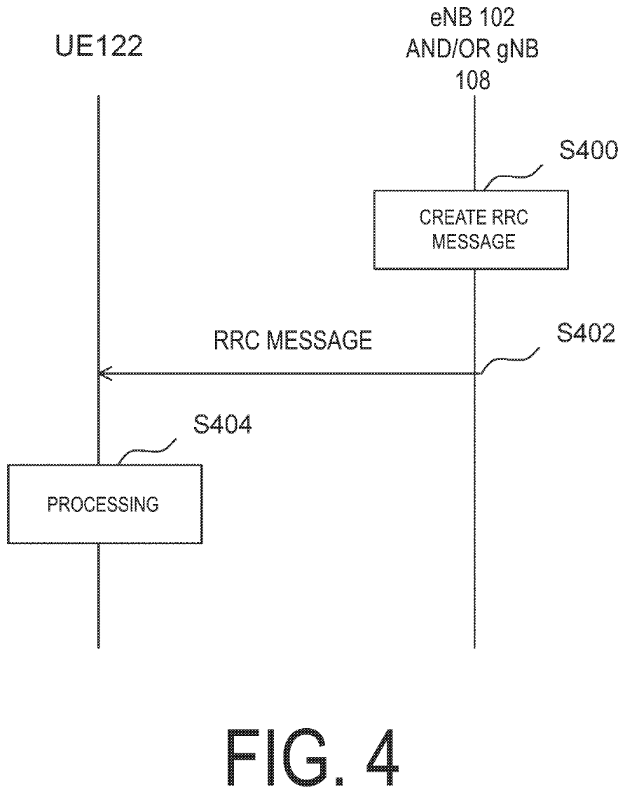

A flow of the RRC message transmitted and/or received between the terminal apparatus and the base station apparatus will be described. FIG. 4 is a diagram illustrating an example of a flow of a procedure for various configurations in the RRC according to an embodiment of the present invention. FIG. 4 is an example of a flow of a case in which the RRC message is transmitted from the base station apparatus (eNB 102 and/or gNB 108) to the terminal apparatus (UE 122).

In FIG. 4, the base station apparatus creates an RRC message (step S400). The creation of the RRC message in the base station apparatus may be performed so that the base station apparatus distributes broadcast information (System Information (SI)) and paging information. The creation of the RRC message in the base station apparatus may be performed so that the base station apparatus causes a specific terminal apparatus to perform processing. The processing that the specific terminal apparatus is caused to perform may include, for example, processing such as configuration related to security, reconfiguration of RRC connection, handover to a different RAT, suspension of RRC connection, and release of RRC connection. The processing of reconfiguration of RRC connection may include, for example, processing such as control (establishment, change, release, or the like) of a radio bearer, control (establishment, addition, change, release, or the like) of a cell group, measurement configuration, handover, and security key update. The creation of the RRC message in the base station apparatus may be performed for a response to an RRC message transmitted from the terminal apparatus. The response to the RRC message transmitted from the terminal apparatus may include, for example, a response to an RRC setup request, a response to an RRC reconnection request, a response to an RRC resume request, and the like. The RRC message includes parameters for various information notifications and configurations. These parameters may be referred to as fields and/or information elements, and may be notated by using a notation method referred to as Abstract Syntax Notation One (ASN.1). Note that, in an embodiment of the present invention, a parameter may be referred to as information.

In FIG. 4, the base station apparatus then transmits the RRC message created, to the terminal apparatus (step S402). Then, in a case that processing such as a configuration is necessary in accordance with the RRC message received, the terminal apparatus performs the processing (step S404). The terminal apparatus that has performed the processing may transmit an RRC message for a response to the base station apparatus (not illustrated).

In addition to the example described above, the RRC message may be used for other purposes as well.

Note that, in MR-DC, the RRC on the master node side may be used for transfer of the RRC message for the configuration (cell group configuration, radio bearer configuration, measurement configuration, and the like) on the SCG side to and from the terminal apparatus. For example, in EN-DC or NGEN-DC, the RRC message of E-UTRA transmitted and/or received between the eNB 102 and the UE 122 may include the RRC message of NR in a form of a container. In NE-DC, the RRC message of NR transmitted and/or received between the gNB 108 and the UE 122 may include the RRC message of E-UTRA in a form of a container. The RRC message for the configuration on the SCG side may be transmitted and/or received between the master node and the secondary node.

Note that an embodiment is not limited to a case that MR-DC is used, and the RRC message for E-UTRA transmitted from the eNB 102 to the UE 122 may include the RRC message for NR, and the RRC message for NR transmitted from the gNB 108 to the UE 122 may include the RRC message for E-UTRA.

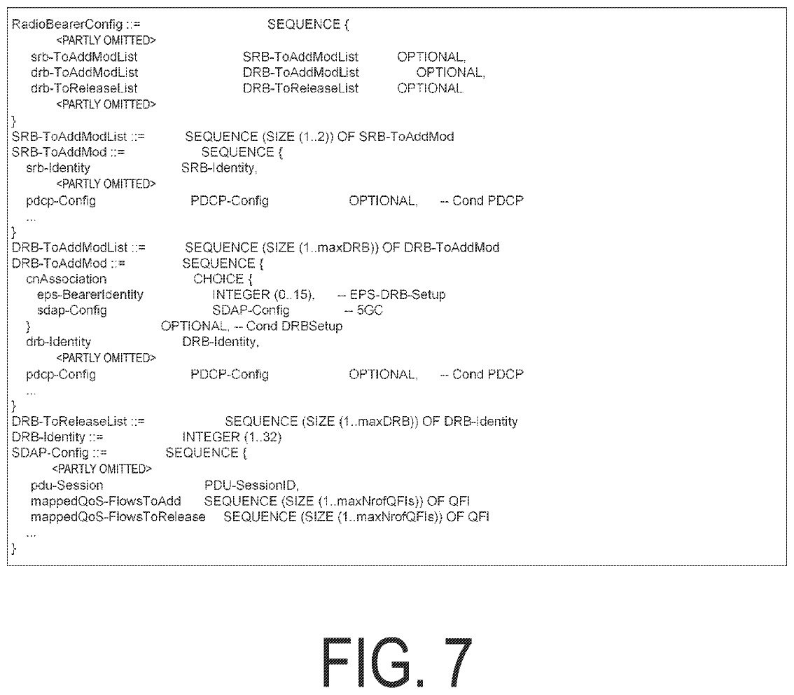

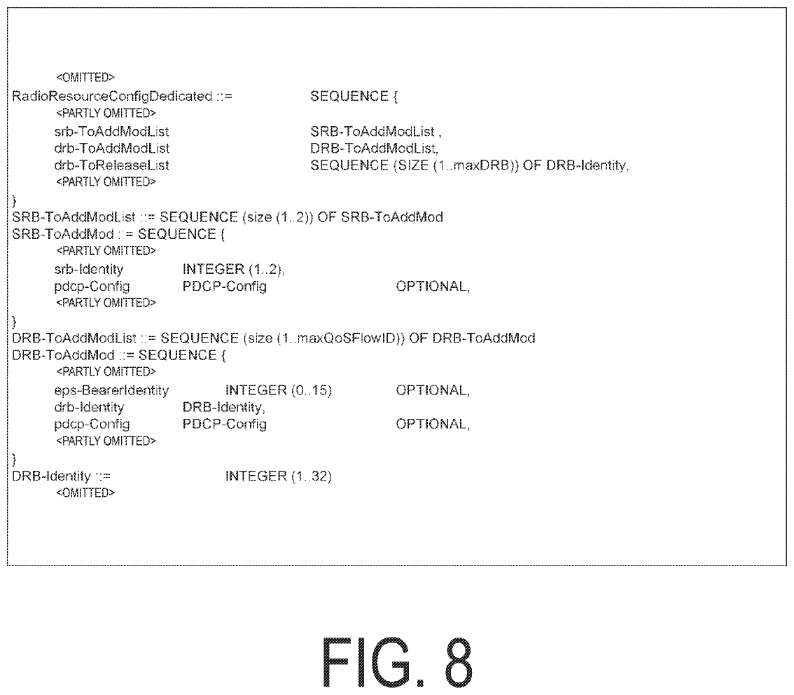

An example of the parameters included in the RRC message related to reconfiguration of RRC connection will be described. FIG. 7 is an example of an ASN.1 notation representing a field and/or an information element related to a radio bearer configuration included in a message related to reconfiguration of RRC connection in NR in FIG. 4. FIG. 8 is an example of an ASN.1 notation representing a field and/or an information element related to a radio bearer configuration included in a message related to reconfiguration of RRC connection in E-UTRA in FIG. 4. Not only in the figures of FIG. 7 and FIG. 8, but also in examples of the ASN.1 according to an embodiment of the present invention, <omitted> and <partly omitted> are not a part of the notation of the ASN.1 and indicate that other information is omitted at these positions. Note that there may also be omitted information elements in a part where neither <omitted> nor <partly omitted> is indicated. Note that, in an embodiment of the present invention, the examples of the ASN.1 do not correctly comply with the ASN.1 notation method. In an embodiment of the present invention, the examples of the ASN.1 are notations of examples of parameters of the RRC message according to an embodiment of the present invention, and other terms and other notations may be used. The examples of ASN.1 correspond to only examples related to main information closely associated with an aspect of the present invention in order to avoid complicated description. Note that the parameters notated in ASN.1 may all be referred to as information elements without distinction between fields, information elements, or the like. In an embodiment of the present invention, fields, information elements, and the like included in the RRC message and notated in ASN.1 may be referred to as information, or may be referred to as parameters. Note that the message related to reconfiguration of RRC connection may be an RRC reconfiguration message in NR or an RRC connection reconfiguration message in E-UTRA.

An information element represented by RadioBearerConfig in FIG. 7 may be an information element used for configuration, modification, release, and the like of a radio bearer such as an SRB and a DRB. The information element represented by RadioBearerConfig may include a PDCP configuration information element and an SDAP configuration information element to be described later. The information element represented by RadioBearerConfig may be referred to as a radio bearer configuration information element or a radio bearer configuration. An information element represented by SRB-ToAddMod included in the information element represented by RadioBearerConfig may be an information element indicating a signalling radio bearer (SRB) configuration. The information element represented by SRB-ToAddMod may be referred to as an SRB configuration information element or an SRB configuration. An information element represented by SRB-ToAddModList may be a list of SRB configurations.

An information element represented by DRB-ToAddMod included in the information element represented by RadioBearerConfig may be an information element indicating a data radio bearer (DRB) configuration. The information element represented by DRB-ToAddMod may be referred to as a DRB configuration information element or a DRB configuration. An information element represented by DRB-ToAddModList may be a list of DRB configurations. Note that the SRB configuration and the DRB configuration may each be referred to as a radio bearer configuration.

A field represented by srb-Identity in the SRB configuration information element may be information of an SRB Identity of an SRB to be added or modified, and may be an identity for uniquely identifying the SRB in each terminal apparatus. The field represented by srb-Identity in the SRB configuration information element may be referred to as an SRB identity field or an SRB identity. The SRB identity may be referred to as a radio bearer identity.

A field represented by drb-Identity in the DRB configuration information element may be information of a DRB Identity of a DRB to be added or modified, and may be an identity for uniquely identifying the DRB in each terminal apparatus. The field represented by drb-Identity in the DRB configuration information element may be referred to as a DRB identity field or a DRB identity. In the example of FIG. 7, a value of the DRB identity is an integer value from 1 to 32, but may be another value. In a case of DC, the DRB identity may be specific within a scope of the UE 122. The DRB identity may be referred to as a radio bearer identity.

A field represented by cnAssociation in the DRB configuration information element may be a field indicating whether the radio bearer is associated with a field represented by eps-beareridentity to be described later, or is associated with an information element represented by SDAP-Config to be described later. The field represented by cnAssociation may be referred to as a core network association field or a core network association. The field represented by cnAssociation may include an EPS bearer identity field (eps-bearerIdentity) to be described later in a case that the terminal apparatus is connected to the EPC 104. The field represented by cnAssociation may include an information element (SDAP-Config) indicating an SDAP configuration to be described later in a case that the terminal apparatus is connected to the core network 5GC 110. The field represented by eps-bearerIdentity may be a field indicating an EPS bearer identity for identifying an EPS bearer. The field represented by eps-bearerIdentity may be referred to as an EPS bearer identity field or an EPS bearer identity.

The information element represented by SDAP-Config may be information related to a configuration or a reconfiguration of the SDAP entity. The information element represented by SDAP-Config may be referred to as an SDAP configuration information element or an SDAP configuration.

A field represented by pdu-session included in the SDAP configuration information element may be a PDU session identifier of a PDU session to which a QoS flow mapped to the radio bearer belongs. The field represented by pdu-session may be referred to as a PDU session identifier field or a PDU session identifier. The PDU session identifier may be a PDU session identifier of a PDU session. The radio bearer may be a DRB associated with a DRB identity of a DRB configuration including the SDAP configuration field.

A field represented by mappedQoS-FlowsToAdd included in the SDAP configuration information element may be information indicating a list of QoS flow identity (QoSFlow Identity (QFI)) fields of an uplink QoS flow to be additionally mapped to the radio bearer. The field represented by mappedQoS-FlowsToAdd may be referred to as a QoS flow field to be added or a QoS flow to be added. The QoS flow may be a QoS flow of a PDU session indicated by a PDU session included in the SDAP configuration information element. The radio bearer may be a DRB associated with a DRB identity of a DRB configuration including the SDAP configuration field.

A field represented by mappedQoS-FlowsToRelease included in the SDAP configuration information element may be information indicating a list of QoS flow identity information elements of a QoS flow whose correspondence is to be released out of QoS flows mapped to the radio bearer. The field represented by mappedQoS-FlowsToRelease may be referred to as a QoS flow field to be released or a QoS flow to be released. The QoS flow may be a QoS flow of a PDU session indicated by a PDU session included in the SDAP configuration information element. The radio bearer may be a DRB associated with a DRB identity of a DRB configuration including the SDAP configuration field.

In addition to the above, the SDAP configuration information element may include a field indicating whether or not an uplink SDAP header is present in uplink data to be transmitted via the radio bearer, a field indicating whether or not a downlink SDAP header is present in downlink data to be received via the radio bearer, a field indicating whether or not the radio bearer is a default radio bearer (default DRB), and the like. The radio bearer may be a DRB associated with a DRB identity of a DRB configuration including the SDAP configuration field.

An information element represented by PDCP-Config in the SRB configuration information element and the DRB configuration information element may be an information element related to a configuration of an NR PDCP entity. The information element represented by PDCP-Config may be referred to as a PDCP configuration information element or a PDCP configuration. The information element related to the configuration of the NR PDCP entity may include a field indicating an uplink sequence number size, a field indicating a downlink sequence number size, a field indicating a profile of header compression (RObust Header Compression (ROHC)), a field indicating a value of the re-ordering timer, and the like.

An information element represented by DRB-ToReleaseList included in the information element represented by RadioBearerConfig may include information indicating one or more DRB identities to be released.

In FIG. 8, an information element represented by RadioResourceConfigDedicated may be an information element used for configuration, modification, release, and the like of a radio bearer. An information element represented by SRB-ToAddMod included in the information element represented by RadioResourceConfigDedicated may be information indicating a signalling radio bearer (SRB) configuration. The information element represented by SRB-ToAddMod may be referred to as an SRB configuration information element or an SRB configuration. An information element represented by SRB-ToAddModList may be a list of pieces of information indicating the SRB configuration. An information element represented by DRB-ToAddMod included in the information element represented by RadioResourceConfigDedicated may be information indicating a data radio bearer (DRB) configuration. The information element represented by DRB-ToAddMod may be referred to as a DRB configuration information element or a DRB configuration. The information element represented by DRB-ToAddModList may be a list of pieces of information indicating the DRB configuration. Note that one or all of the SRB configuration and the DRB configuration may be referred to as a radio bearer configuration.

A field represented by srb-Identity in the SRB configuration information element may be information of an SRB Identity of an SRB to be added or modified, and may be an identity for uniquely identifying the SRB in each terminal apparatus. The field represented by sib-Identity in the SRB configuration information element may be referred to as an SRB identity field or an SRB identity. The SRB identity may be referred to as a radio bearer identity. The SRB identity of FIG. 8 may have the same function as the SRB identity of FIG. 7.

A field represented by drb-Identity in the DRB configuration may be information of a DRB Identity of a DRB to be added or modified, and may be an identity for uniquely identifying the DRB in each terminal apparatus. The field represented by drb-Identity in the DRB configuration information element may be referred to as a DRB identity field or a DRB identity. In the example of FIG. 8, a value of the DRB identity is an integer value from 1 to 32, but may be another value. The DRB identity may be referred to as a radio bearer identity. The DRB identity of FIG. 8 may have the same function as the DRB identity of FIG. 7.

A field represented by eps-BearerIdentity in the DRB configuration information element may be an EPS bearer identity for uniquely identifying the EPS bearer in each terminal apparatus. The field represented by eps-BearerIdentity may be referred to as an EPS bearer identity field or an EPS bearer identity. In the example of FIG. 8, a value of the EPS bearer identity is an integer value from 1 to 15, but may be another value. The EPS bearer identity of FIG. 8 may have the same function as the EPS bearer identity of FIG. 7. The EPS bearer identity and the DRB identity may correspond to each other on a one-to-one basis in each terminal apparatus.

An information element represented by PDCP-Config in the SRB configuration information element and the DRB configuration information element may be an information element related to a configuration of an E-UTRA PDCP entity. The information element represented by PDCP-Config may be referred to as a PDCP configuration information element or a PDCP configuration. The information element related to the configuration of the E-UTRA PDCP entity may include a field indicating a sequence number size, a field indicating a profile of header compression (RObust Header Compression (ROHC)), a field indicating a value of the re-ordering timer, and the like.

The SRB configuration information element illustrated in FIG. 8 may further include a field related to an E-UTRA RLC entity configuration (not illustrated). The field related to the E-UTRA RLC entity configuration may be referred to as an RLC configuration field or an RLC configuration. The SRB configuration information element illustrated in FIG. 8 may include an information element related to a logical channel configuration (not illustrated). The information element related to the logical channel configuration may be referred to as a logical channel configuration information element or a logical channel configuration.

The DRB configuration information element illustrated in FIG. 8 may further include an information element related to an E-UTRA RLC entity configuration (not illustrated). The information element related to the E-UTRA RLC entity configuration may be referred to as an RLC configuration information element or an RLC configuration. The DRB configuration information element illustrated in FIG. 8 may include a field indicating logical channel identity (ID) information. The field indicating the logical channel identity (ID) information may be referred to as a logical channel identity field or a logical channel identity. The DRB configuration information element illustrated in FIG. 8 may include an information element related to a logical channel configuration (not illustrated). The information element related to the logical channel configuration may be referred to as a logical channel configuration information element or a logical channel configuration. Note that the logical channel identity may be associated with the radio bearer identity.

An information element represented by DRB-ToReleaseList included in the information element represented by RadioResourceConfigDedicated may include information indicating one or more DRB identities to be released.

Note that, in NR, information elements related to an RLC bearer configuration, such as an information element related to an NR RLC entity configuration for each radio bearer, an information element indicating logical channel identity (ID) information, and an information element related to a logical channel configuration, may be included not in the information element represented by RadioBearerConfig of FIG. 7 but in an information element related to a cell group configuration (not illustrated). The information element related to the cell group configuration may be included in a message related to a reconfiguration of RRC connection. The information element related to the cell group configuration may be referred to as a cell group configuration information element or a cell group configuration. The information element related to the NR RLC entity configuration may be referred to as an RLC configuration information element or an RLC configuration. The information element indicating the logical channel identity information may be referred to as a logical channel identity information element or a logical channel identity. The information element related to the logical channel configuration may be referred to as a logical channel configuration information element or a logical channel identity. Note that the logical channel identity may be associated with the radio bearer identity.

A part or all of the fields and the information elements described with reference to FIG. 7 or FIG. 8 may be optional. In other words, the fields and the information elements described with reference to FIG. 7 or FIG. 8 may be included in a message related to a reconfiguration of RRC connection, as necessary or depending on a condition. The message related to the reconfiguration of RRC connection may include a field indicating application of a full configuration and the like, in addition to the information element related to a configuration of a radio bearer. The field indicating application of the full configuration may be represented by an information element name of fullConfig or the like, or application of the full configuration may be indicated using true, enable, or the like.

Based on the description in the above, various embodiments of the present invention will be described. Note that the process described in the above may be applied to each process not described in the following.

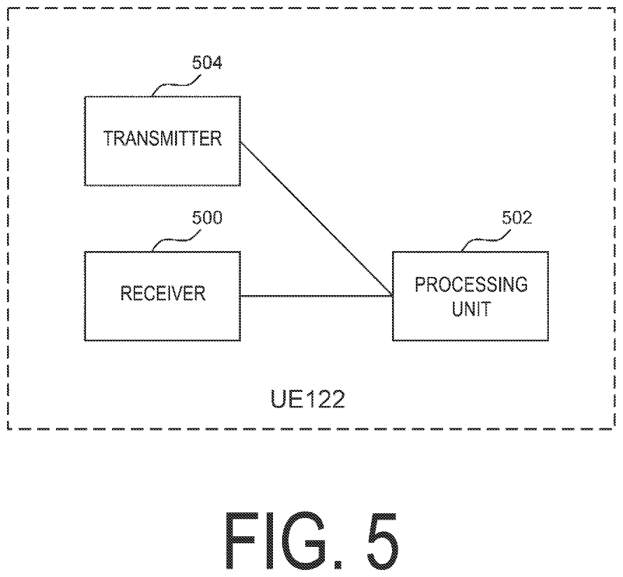

FIG. 5 is a block diagram illustrating a configuration of the terminal apparatus (UE 122) according to an embodiment of the present invention. Note that FIG. 5 illustrates only the main components closely related to an aspect of the present invention in order to avoid complexity of description.

The UE 122 illustrated in FIG. 5 includes a receiver 500 that receives an RRC message and the like from the base station apparatus, a processing unit 502 that performs processing in accordance with parameters included in a received message, and a transmitter 504 that transmits an RRC message and the like to the base station apparatus. The base station apparatus may be the eNB 102, or may be the gNB 108. The processing unit 502 may include a part or all of functions of various layers (for example, the physical layer, the MAC layer, the RLC layer, the PDCP layer, the SDAP layer, the RRC layer, and the NAS layer). In other words, the processing unit 502 may include a part or all of a physical layer processing unit, a MAC layer processing unit, an RLC layer processing unit, a PDCP layer processing unit, an SDAP processing unit, an RRC layer processing unit, and a NAS layer processing unit.

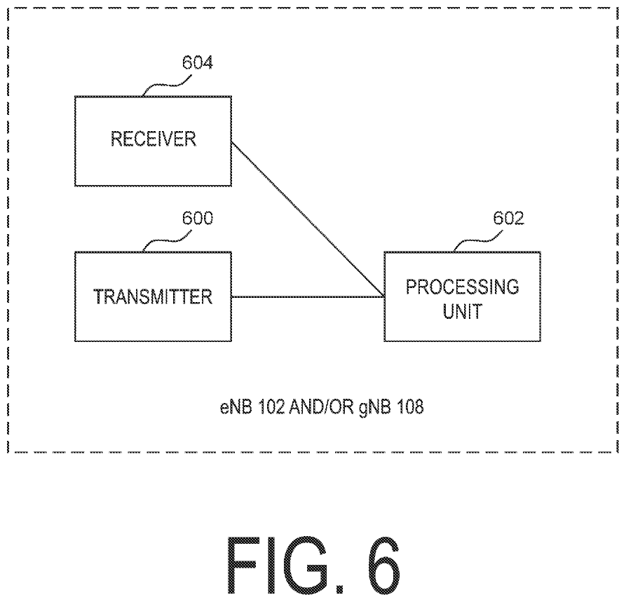

FIG. 6 is a block diagram illustrating a configuration of the base station apparatus according to an embodiment of the present invention. Note that FIG. 6 illustrates only the main components closely related to an aspect of the present invention in order to avoid complexity of description. The base station apparatus may be the eNB 102, or may be the gNB 108.

The base station apparatus illustrated in FIG. 6 includes a transmitter 600 that transmits an RRC message and the like to the UE 122, a processing unit 602 that creates an RRC message including parameters and transmits the RRC message to the UE 122 to thereby cause the processing unit 502 of the UE 122 to perform processing, and a receiver 604 that receives an RRC message and the like from the UE 122. The processing unit 602 may include a part or all of functions of various layers (for example, the physical layer, the MAC layer, the RLC layer, the PDCP layer, the SDAP layer, the RRC layer, and the NAS layer). In other words, the processing unit 602 may include a part or all of a physical layer processing unit, a MAC layer processing unit, an RLC layer processing unit, a PDCP layer processing unit, an SDAP processing unit, an RRC layer processing unit, and a NAS layer processing unit.

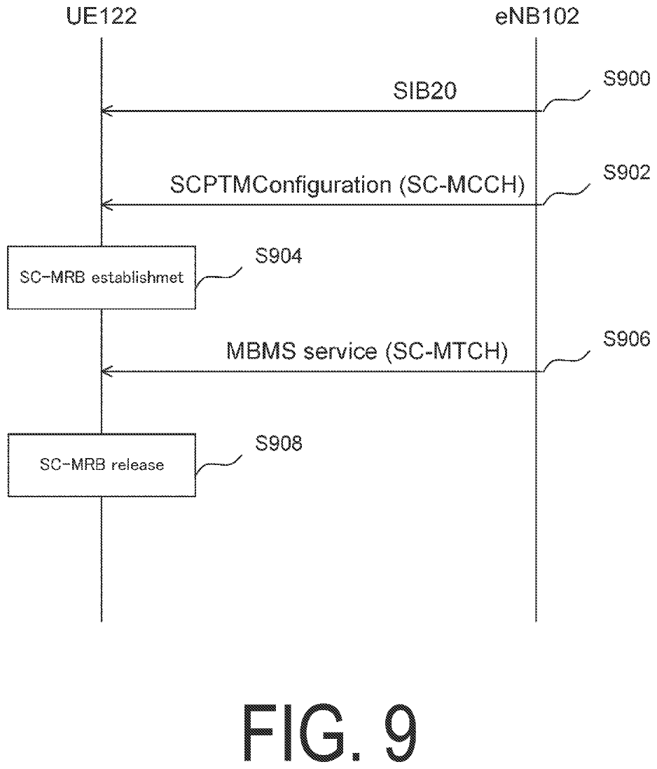

With reference to FIG. 9 to FIG. 11, an overview of operations of MBMS transmission/reception using the SC-PTM will be described. Note that an MBMS, an MBMS service, and an MBMS session, which are terms to be used in the following description, may be terms having the same meanings and may be replaced with each other.

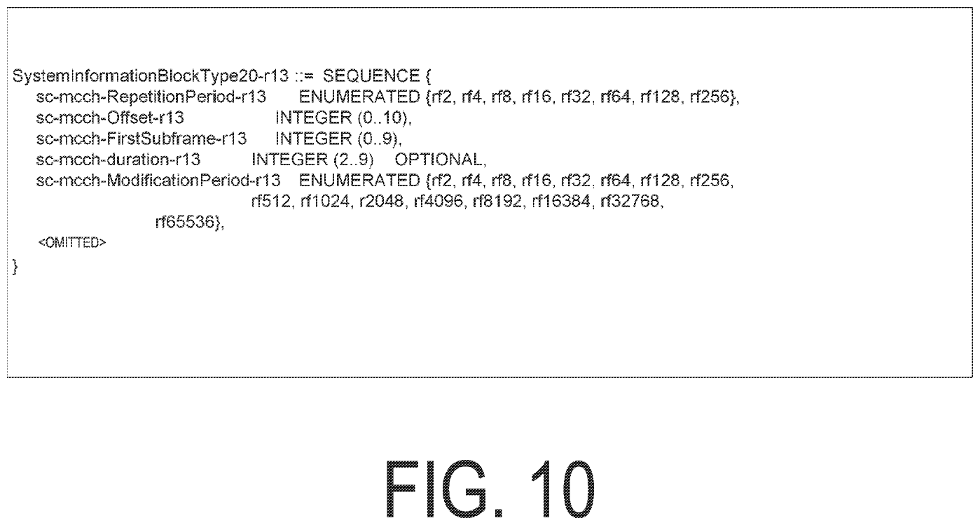

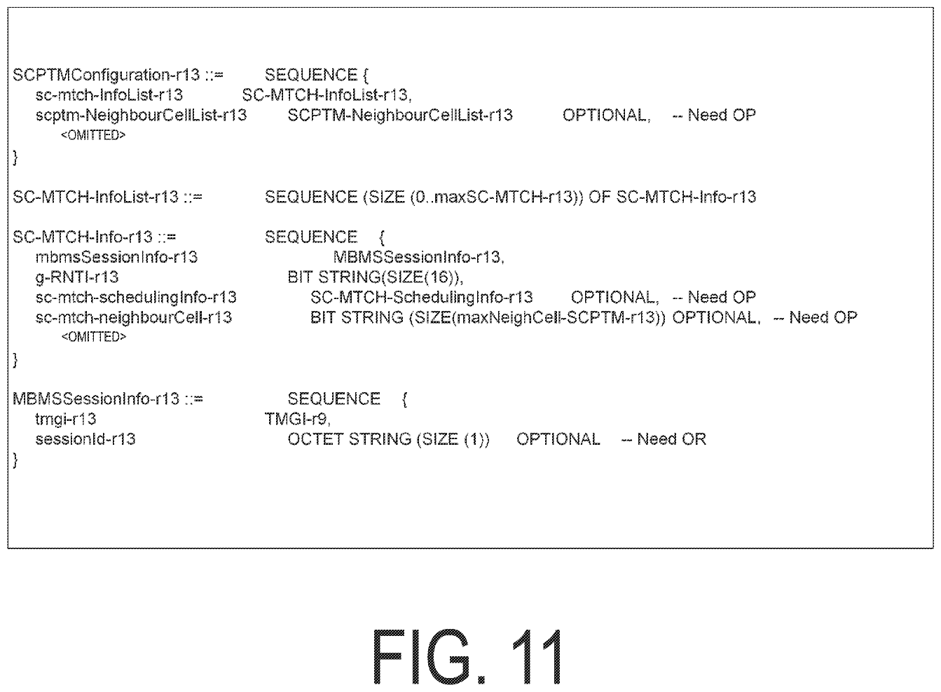

FIG. 9 is a diagram illustrating a flow of a procedure for configuration of MBMS reception using the SC-PTM. FIG. 10 is a diagram illustrating an example of ASN.1 notation representing fields and/or information elements included in System Information Block Type 20 (SIB20) of FIG. 9. FIG. 11 is a diagram illustrating an example of ASN.1 notation representing fields and/or information elements included in an SC-PTM configuration message (SCPTMConfiguration) of FIG. 9.

As illustrated in FIG. 9, the processing unit 602 of the eNB 102 creates the System Information Block type 20 (SIB20) being an RRC message, and transmits the SIB20 from the transmitter 600 to the UE 122 via the BCCH. The receiver 500 of the UE 122 receives the SIB20. (Step S900).

The SIB20 includes information necessary for acquisition of control information (specifically, the SC-MCCH) related to transmission of the MBMS using the SC-PTM. For example, the SIB20 includes a part or all of fields, such as a field represented by sc-mcch-ModificationPeriod indicating a period for which details of the SC-MCCH may be changed, a field represented by sc-mcch-RepetitionPeriod indicating a transmission (retransmission) time interval of the SC-MCCH with the number of radio frames, a field represented by sc-mcch-Offset indicating an offset of the radio frame in which the SC-MCCH is scheduled, a field represented by sc-mcch-FirstSubframe indicating the subframe in which the SC-MCCH is scheduled, and a field represented by sc-mcch-duration indicating a period of the subframe in which the SC-MCCH is scheduled, and/or information elements.

Next, the processing unit of the eNB 102 creates an SC-PTM configuration message (SCPTM Configuration) being an RRC message, and transmits the SC-PTM configuration message from the transmitter 600 via the SC-MCCH. The receiver 500 of the UE 122 receives SC-PTM configuration information, based on the configuration of the SIB20. In the physical layer, a Single Cell RNTI (SC-RNTI) is used for transmission of the SC-MCCH. (Step S902).

The SC-PTM configuration information includes control information that can be applied to MBMS reception. For example, the SC-PTM configuration information includes a part or all of fields, such as a field represented by sc-mtch-InfoList including the configuration of each SC-MTCH in a cell for transmitting the information and a field represented by scptm-NeighbourCellList being a list of neighbor cells that provide the MBMS, and/or information elements.

sc-mtch-InfoList includes one or multiple information elements represented by SC-MTCH-Info. Each SC-MTCH-Info includes a part or all of fields, such as a field represented by mbmsSessionInfo being information of the MBMS session, a field represented by g-RNTI being a Radio Network Temporary Identifier (RNTI) for identifying a multicast group (specifically, the SC-MTCH addressed to a specific group), a field represented by sc-mtch-schedulingInfo being DRX information for SC-MTCH, and a field represented by sc-mtch-neighbourCell being information of a neighboring cell from which the MBMS session can be received using the SC-MTCH. mbmsSessionInfo includes a part or all of fields, such as a field represented by tmgi being a Temporary Mobile Group Identity (TMGI), which is an identifier for identifying an MBMS bearer service, and a field represented by sessionId being an identifier of the MBMS session.

In order to start reception of the MBMS session in which the processing unit 502 of the UE 122 is interested, the processing unit 502 may perform Single Cell MBMS Point to Multipoint Radio Bearer (SC-MRB) establishment processing, the SC-MRB being a radio bearer for MBMS session reception using the SC-PTM (Step S904). For example, the SC-MRB establishment processing may be started in a case of starting the MBMS session, a case that the UE 122 enters a cell where the MBMS service in which the UE 122 is interested is provided via the SC-MRB, a case of starting to take an interest in the MBMS service, a case that a restriction on a UE capability that has restricted reception of the MBMS service is removed, and the like. The SC-MRB establishment processing may be performed in a case that the UE 122 is in the RRC_IDLE state, or may be performed in a case that the UE 122 is in the RRC_CONNECTED state. In a case of performing the SC-MRB establishment processing, the processing unit 502 of the UE 122 may perform a part or all of the following processing of (A) to (D):
(A) establish the RLC entity according to a default configuration of the SC-MCCH and the SC-MTCH;
(B) configure an SC-MTCH logical channel to be applied to the SC-MRB to be established, and instruct the MAC entity to be capable of receiving the MBMS session according to the SC-PTM configuration message for a cell in which the SC-PTM configuration message is received;
(C) configure the physical layer for the SC-MRB to be established, based on sc-mtch-InfoList described above;
(D) notify an upper layer of tmgi and sessionid corresponding to the established SC-MRB and thereby notify the upper layer of establishment of the SC-MRB.

The processing unit 502 of the UE 122 receives the MBMS session via the established SC-MRB according to the SC-PTM configuration message (Step S906). Before receiving the MBMS session, the processing unit 502 of the UE 122 may create an MBMS interest report message (MBMSInterestIndication), which is for reporting to the eNB 102 that the UE 122 is to receive or is interested in receiving the MBMS service via the SC-MRB, and transmit the MBMS interest report message from the transmitter 504 to the eNB 102 (not illustrated). The MBMS interest report message may include information as to whether or not to prioritize MBMS service reception over unicast reception. The MBMS interest report message may be transmitted after the SIB20 is received, in a case of transition to the RRC_CONNECTED state, or after transition to the RRC_CONNECTED state. The MBMS interest report message may be transmitted in a case that the SIB20 is received in a case of handover, or may be transmitted in a case that the SIB20 is received in a case of re-establishment of the RRC connection.

The processing unit 502 of the UE 122 may perform SC-MRB release processing in order to stop reception of the MBMS session (Step S908). For example, the SC-MRB release processing may be started in a case of stopping the MBMS session being received, a case of leaving from a cell in which the SC-MRB is established, a case that the interest in the MBMS service is lost, a case that reception of the MBMS service is restricted due to the restriction on the UE capability, and the like. The SC-MRB release processing may be performed in a case that the UE 122 is in the RRC_IDLE state, or may be performed in a case that the UE 122 is in the RRC_CONNECTED state. In a case of performing the SC-MRB release processing, the processing unit 502 of the UE 122 may perform a part or all of the following processing of (A) to (B):
(A) release a physical layer configuration with the RLC entity of the SC-MRB to be released and the MAC related thereto;
(B) notify an upper layer of tmgi and sessionId corresponding to the released SC-MRB and thereby notify the upper layer of release of the SC-MRB.

In the above, an overview of operations related to the configuration of MBMS reception using the SC-PTM has been described. MBMS transmission/reception using the MBSFN has also been standardized in addition to MBMS transmission from the base station apparatus/MBMS reception in the terminal apparatus using the SC-PTM (hereinafter referred to as MBMS transmission/reception). However, the MBMS transmission/reception using the SC-PTM and the MBMS transmission/reception using the MBSFN use E-UTRA as their RATs. Multicast Broadcast Service (MBS) transmission/reception using NR as its RAT has not yet been standardized.

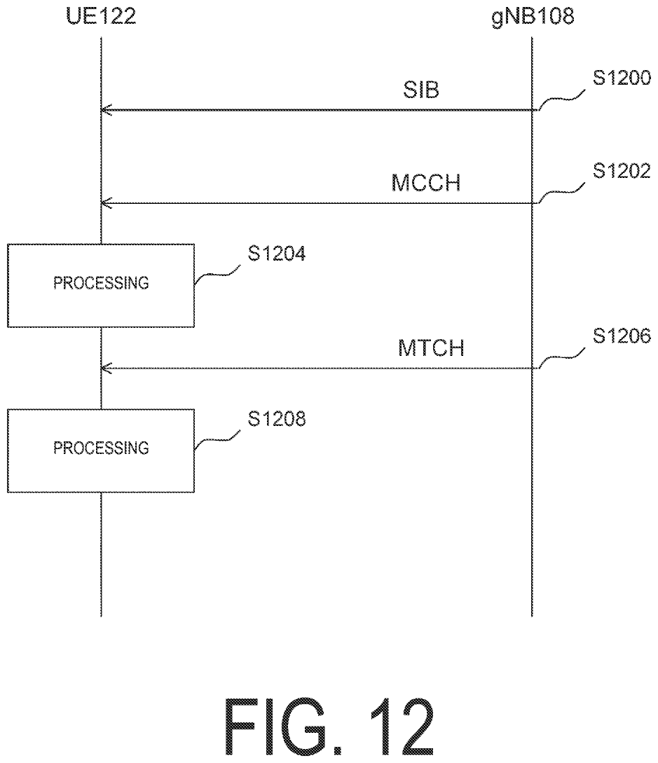

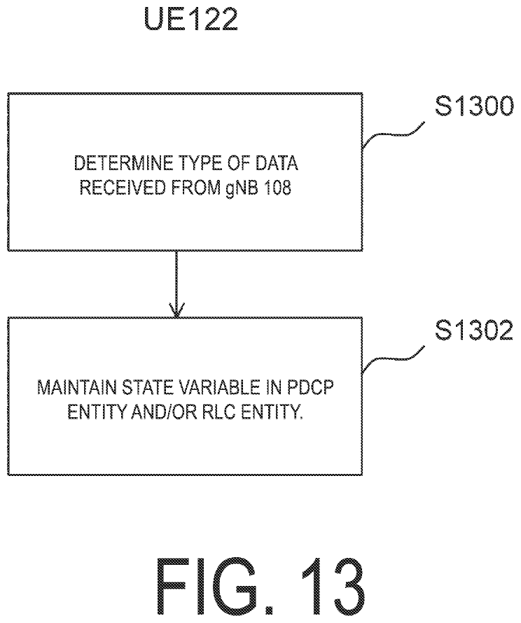

With reference to FIG. 12 to FIG. 13, an example of operations of the UE 122 and the gNB 108 according to an embodiment of the present invention will be described. Note that an MBS, an MBS service, an MBS session, and an MBS bearer, which are terms to be used in an embodiment of the present invention, may be terms having the same meanings and may be replaced with each other. The MBS, the MBS service, and the MBS session, which are terms to be used in an embodiment of the present invention, may be terms having the same meanings as the MBMS, the MBMS service, and the MBMS session. In an embodiment of the present invention, for the UE 122, a radio bearer for the MBS may be established and/or configured for MBS reception. In the gNB 108, the radio bearer for the MBS may be established and/or configured for MBS transmission. In an embodiment of the present invention, the radio bearer for the MBS will be described using a term “Multicast Radio Bearer (MRB)”, but another term may be used. In an embodiment of the present invention, the MRB established and/or configured for the UE 122 may be an MRB for receiving the MBS using Point-to-Multipoint connection, or may be an MRB for receiving the MBS using Point-to-Point connection. In an embodiment of the present invention, the MRB for receiving the MBS using Point-to-Multipoint connection and the MRB for receiving the MBS using Point-to-Point connection may be the same MRB. In other words, one MRB may have a capability of receiving the MBS using point-to-multipoint connection and a capability of receiving the MBS using point-to-point connection. In a case that one MRB has the capability of receiving the MBS using point-to-multipoint connection and the capability of receiving the MBS using point-to-point connection, the MRB may include one or multiple RLC bearers for receiving and/or transmitting the MBS using point-to-multipoint connection and one or multiple RLC bearers for receiving and/or transmitting the MBS using point-to-point connection. In a case that one MRB has the capability of receiving the MBS using point-to-multipoint connection and the capability of receiving the MBS using point-to-point connection, one or multiple RLC bearers for receiving and/or transmitting the MBS using point-to-multipoint connection and one or multiple RLC bearers for receiving and/or transmitting the MBS using point-to-point connection may be associated with one PDCP entity. One or multiple QoS flows may be associated with the MRB. Note that the MRB for receiving the MBS using Point-to-Point connection may be the DRB.

To receive and/or transmit the MBS using point-to-multipoint connection may be to receive and/or transmit the MBS via a logical channel for multicasting, such as the MTCH and the SC-MTCH. To receive and/or transmit the MBS using point-to-point connection may be to receive and/or transmit the MBS via a logical channel for dedicated user data, such as the DTCH. Note that, in an embodiment of the present invention, to receive and/or transmit the MBS using point-to-multipoint connection may be interpreted as to receive and/or transmit the MBS using multicasting. In an embodiment of the present invention, to receive and/or transmit the MBS using point-to-point connection may be interpreted as to receive and/or transmit the MBS using unicasting. In a case that the MBS is received and/or transmitted using point-to-point connection, security may be applied. In a case that the MBS is received and/or transmitted using point-to-multipoint connection, security need not be applied. The security may refer to ciphering and deciphering, and/or integrity protection and verification.

FIG. 12 is a diagram illustrating an example of a flow of an MBS reception procedure in NR according to an embodiment of the present invention. Note that, in the present embodiment, parameters and/or pieces of information may refer to fields and/or information elements in ASN.1.

As illustrated in FIG. 12, in order to broadcast information necessary for acquisition of control information related to the MBS transmission, the processing unit 602 of the gNB 108 may create a first System Information Block (SIB) being a type of RRC message, and transmit the SIB from the transmitter 600 to the UE 122. The receiver 500 of the UE 122 receives the first SIB. Note that the first SIB may be transmitted via a BCCH logical channel, or may be transmitted via another logical channel. The information necessary for acquisition of control information related to the MBS transmission may be information related to a Multicast Control Channel (MCCH) logical channel (which may be hereinafter referred to as an MCCH). The MCCH may be a point-to-multipoint downlink channel for transmitting MBS control information, and/or MBS configuration information, and/or MBS information for one or multiple Multicast Traffic Channel (MTCH) logical channels (which may be hereinafter referred to as MTCHs) from the gNB 108 to the UE 122. The MTCH may be a point-to-multipoint downlink channel for transmitting data of the MBS from the gNB 108 to the UE 122. The MCCH may be a multicast control channel. The MTCH may be a multicast traffic channel. The MTCH may be used by the UE 122 only in a case that the UE 122 receives the MBS. Note that other terms may be used to refer to the MCCH, such as an MBS-MCCH and an NR-MCCH. Note that other terms may be used to refer to the MTCH, such as an MBS-MTCH and an NR-MTCH. The MCCH may be mapped to a Multicast Channel (MCH) being a downlink transport channel, or may be mapped to a Downlink Shared Channel (DL-SCH) being a downlink transport channel. The MTCH may be mapped to a Multicast Channel (MCH) being a downlink transport channel, or may be mapped to a Downlink Shared Channel (DL-SCH) being a downlink transport channel. The MBS control information, and/or the MBS configuration information, and/or the MBS information for one or multiple MTCH logical channels may be included in the first SIB, or may be included in a second SIB that is different from the first SIB. (Step S1200)

For example, the first SIB may include a part or all of parameters, such as a parameter indicating a period for which details of the MCCH may be changed, a parameter related to a transmission (retransmission) time interval of the MCCH, a parameter indicating an offset of the radio frame in which the MCCH is scheduled, a parameter indicating a slot in which the MCCH is scheduled, and a parameter indicating a period of the slot in which the MCCH is scheduled. Note that the parameter related to the transmission (retransmission) time interval of the MCCH may be represented by the number of radio frames.

Next, the processing unit of the gNB 108 may create an RRC message to be transmitted on the MCCH, and transmit the RRC message from the transmitter 600. The receiver 500 of the UE 122 may receive the RRC message transmitted on the MCCH, based on the configuration of the first SIB. For the transmission of the MCCH, a dedicated Radio Network Temporary Identifier (RNTI) for identifying the MCCH transmission may be used. As a value of the dedicated RNTI for identifying the MCCH transmission, a specific value may be used, or a value may be configured by the first SIB. In an embodiment of the present invention, a message name of MBS configuration information message is used to refer to the RRC message to be transmitted on the MCCH, but other message names may be used. (Step S1202)

The MBS configuration information message may include one or multiple MBS MTCH parameters, each of which is a parameter for MBS reception. For example, regarding the MBS MTCH parameters, one or multiple MBS MTCH parameters may be included in the MBS configuration information message in a form of a list, so that an information element represented by SC-MTCH-InfoList in FIG. 11 includes one or multiple information elements represented by SC-MTCH-Info in a form of a list. The MBS MTCH parameter may be present for each MBS session. For example, a first MBS MTCH parameter may be present for a first MBS session, and a second MBS MTCH parameter may be present for a second MBS session. Note that, in an embodiment of the present invention, the parameter for MBS reception will be described using a term “MBS MTCH parameter”, but another term may be used.

The MBS MTCH parameters may include a part or all of parameters, such as a parameter related to information of the MBS session, a parameter indicating the RNTI for identifying a multicast group (an MTCH to addressed to a specific group), a parameter indicating the logical channel identity, a parameter related to DRX information for the MTCH, a parameter indicating a list of neighbor cells that provide the same MBS, a parameter indicating whether or not the ROHC is applied to the MBS session, a parameter related to the ROHC used for the MBS session, a parameter related to the Hyper Frame Number (HFN), a parameter related to COUNT, and a parameter related to a timer of the status report. For example, the parameter related to the information of the MBS session may include a part or all of parameters, such as a parameter indicating a Temporary Mobile Group Identity (TMGI) being an identifier for identifying the MBS, a parameter indicating Session ID being an identifier of the MBS (or MBMS) session, a parameter indicating a PDU session to which the MBS session belongs, and a parameter indicating a QoS flow used for the MBS session. A part or all of the MBS MTCH parameters may be included in the first SIB, may be included in the second SIB, or may be included in a third SIB that is different from the first SIB and the second SIB.

Note that the parameter indicating the list of neighbor cells that provide the same MBS may include a parameter indicating a list of neighbor cells that provide the same MBS via the MTCH and/or the MRB, or may include a parameter indicating a list of neighbor cells that provide the same MBS via unicasting, and/or the DTCH, and/or the DRB.

The MBS configuration information message and/or the MBS MTCH parameter may include a parameter related to an MRB configuration. The parameter related to the MRB configuration may include a part or all of parameters including an identifier for identifying the MRB, an SDAP configuration information element, and a PDCP configuration information element. The parameter related to the MRB configuration may include one or multiple RLC bearer configuration information elements. The RLC bearer configuration information elements may include a part or all of an RLC configuration information element for establishing and/or configuring the RLC entity, and a logical channel information element for the logical channel configuration. The RLC bearer configuration information elements may be included in an information element different from the MRB configuration, and may be associated with the parameter related to the MRB configuration with the identifier for identifying the MRB or the like. The MRB configuration may include a parameter for identifying the RLC bearer that receives the MBS using point-to-multipoint connection. The MRB configuration may include a parameter for identifying the RLC bearer that receives the MBS using point-to-point connection. The parameter for identifying the RLC bearer that receives the MBS using point-to-multipoint connection and/or the parameter for identifying the RLC bearer that receives the MBS using point-to-point connection may be the logical channel identity. Note that the parameter indicating whether or not the ROHC is applied to the MBS session, and/or the parameter related to the ROHC used for the MBS session, and/or the parameter related to the Hyper Frame Number (HFN), and/or the parameter related to COUNT, and/or the parameter related to a timer of the status report, and/or the like may be included in the parameter related to the MRB configuration, or may be included in the PDCP configuration information element. The parameter indicating a PDU session, and/or the parameter indicating a QoS flow, and/or the like may be included in the parameter related to the MRB configuration, or may be included in the SDAP configuration information element. The parameter indicating a PDU session may be the PDU session ID.

The UE 122 may receive the MBS configuration information message from the receiver 500, and perform, in the processing unit 502, processing of starting reception of the MBS session of interest. (Step S1204)

In Step S1204, the processing unit 502 of the UE 122 may determine whether or not the ROHC is applied to the MBS session of interest from the MBS configuration information message received in Step S1202. The determination as to whether or not the ROHC is applied to the MBS session of interest may be performed based on whether or not the parameter indicating whether or not the ROHC is applied is included in the MBS configuration information message and/or the MBS MTCH parameter. In other words, in a case that the parameter indicating whether or not the ROHC is applied is included in the MBS configuration information message and/or the MBS MTCH parameter for the MBS session of interest, it may be determined that the ROHC is applied, whereas in a case that the parameter indicating whether or not the ROHC is applied is not included in the MBS configuration information message and/or the MBS MTCH parameter for the MBS session of interest, it may be determined that the ROHC is not applied. The determination as to whether or not the ROHC is applied may be performed based on a value of the parameter indicating whether or not the ROHC is applied included in the MBS configuration information message and/or the MBS MTCH parameter for the MBS session of interest. In other words, in a case that the parameter indicating whether or not the ROHC is applied included in the MBS configuration information message and/or the MBS MTCH parameter for the MBS session of interest is a value indicating that the ROHC is applied, it may be determined that the ROHC is applied, whereas in a case that the parameter indicating whether or not the ROHC is applied included in the MBS configuration information message and/or the MBS MTCH parameter for the MBS session of interest indicates that the ROHC is not applied, it may be determined that the ROHC is not applied. The determination as to whether or not the ROHC is applied may be determined based on whether or not the parameter related to the ROHC used for the MBS session is included in the MBS configuration information message and/or the MBS MTCH parameter for the MBS session of interest. In other words, in a case that the parameter related to the ROHC used for the MBS session is included in the MBS configuration information message and/or the MBS MTCH parameter for the MBS session of interest, it may be determined that the ROHC is applied. In a case that the parameter related to the ROHC used for the MBS session is not included in the MBS configuration information message and/or the MBS MTCH parameter for the MBS session of interest, it may be determined that the ROHC is not applied. Note that the MBS session of interest may be expressed as the session that the UE 122 desires to receive, the session that the UE 122 is to receive, and the like.

Note that the parameter related to the ROHC used for the MBS session may include a part or all of a parameter related to a maximum value of a Context identifier (CID) used for the ROHC, a parameter related to a profile used for the ROHC, and a parameter indicating whether a ROHC header compression protocol is to be continued or reset in a case of PDCP re-establishment. The parameter related to the ROHC used for the MBS session may include a parameter related to timing at which all of the pieces of header information can be obtained. The timing at which all of the pieces of header information can be obtained may be a period in which all of the pieces of header information can be obtained. The parameter related to the timing at which all of the pieces of header information can be obtained may include a part or all of a parameter indicating a period in which a part or whole of all of the pieces of header information may be changed, a parameter indicating a time interval of transmission of all of the pieces of header information with the number of radio frames, a parameter indicating an offset of the radio frame in which transmission of all of the pieces of header information is scheduled, a parameter indicating a slot in which transmission of all of the pieces of header information is scheduled, and a parameter indicating a period (window length) of the slot in which transmission of all of the pieces of header information is scheduled. All of the pieces of header information may be all of the pieces of header information out of pieces of header (the IP header, the UDP header, the TCP header, the RTP header, or the like) information to be compressed in the ROHC. The timing at which all of the pieces of header information can be obtained may be referred to as timing at which ROHC context information can be obtained. The timing at which all of the pieces of header information can be obtained may be referred to as timing of transmission using the IR state, and/or the FO state, and/or the SO state. The timing at which all of the pieces of header information can be obtained may be timing at which the UE 122 starts to receive the MBS or the MTCH. The timing at which all of the pieces of header information can be obtained may be timing at which the UE 122 is to start to receive the MBS or the MTCH.

In Step S1204, the processing unit 502 of the UE 122 that has determined that the ROHC is applied to the MBS session of interest may determine that acquisition of the ROHC context information is necessary, based on that the ROHC is applied to the MBS session of interest. In Step S1204, the processing unit 502 of the UE 122 that has determined that the ROHC is not applied to the MBS session of interest may determine that acquisition of the ROHC context information is not necessary, based on that the ROHC is not applied to the MBS session of interest.

In Step S1204, the processing unit 502 of the UE 122 that has determined that the ROHC is applied to the MBS session of interest or has determined that acquisition of the ROHC context information is necessary may perform processing of acquiring the ROHC context. The processing of acquiring the ROHC context may be processing in which the UE 122 transitions from the RRC_IDLE state or the RRC_INACTIVE state to the RRC_CONNECTED state. The transition of the UE 122 from the RRC_IDLE state to the RRC_CONNECTED state may be performed in the following manner: the UE 122 transmits an RRC setup request message to the gNB 108, and receives an RRC setup message from the gNB 108 as a response message for the RRC setup request message. The transition of the UE 122 from the RRC_INACTIVE state to the RRC_CONNECTED state may be performed in the following manner: the UE 122 transmits an RRC resume request message to the gNB 108, and receives an RRC resume message or an RRC setup message from the gNB 108 as a response message for the RRC resume request message. In a case that the UE 122 transitions from the RRC_IDLE state or the RRC_INACTIVE state to the RRC_CONNECTED state, or after the UE 122 transitions from the RRC_IDLE state or the RRC_INACTIVE state to the RRC_CONNECTED state, the UE 122 may transmit an RRC message including information related to the MBS session of interest to the gNB 108.

For the UE 122 that has transitioned to the RRC_CONNECTED state, an MRB for receiving the MBS session using point-to-point connection or a DRB for receiving the MBS session may be established and/or configured. The MRB for receiving the MBS session using point-to-point connection may be a radio bearer including one or multiple RLC bearers for receiving the MBS session using point-to-multipoint connection and one or multiple RLC bearers for receiving the MBS session using point-to-point connection. To establish and/or configure the MRB for receiving the MBS session using point-to-point connection may refer to a case that an RLC bearer for receiving the MRB session using point-to-point connection is additionally established and/or configured for the MRB including only an RLC bearer for receiving the MRB session using point-to-multipoint connection. The case that the RLC bearer for receiving the MRB session using point-to-point connection is additionally established and/or configured may be a case that the established and/or established RLC bearer for receiving the MBS session using point-to-point connection is associated with the PDCP entity of the MRB including only the RLC bearer for receiving the MRB session using point-to-multipoint connection. The processing of acquiring the ROHC context may be performed by the UE 122 receiving the MBS session of interest using point-to-point connection. (Step S1206)

The processing of acquiring the ROHC context in Step S1204 may be performed by the UE 122 conforming to a parameter related to the ROHC included in the MBS configuration information message and/or the MBS MTCH parameter for the MBS session of interest. For example, the UE 122 may conform to the parameter related to the timing at which all of the pieces of header information can be obtained to acquire information of the timing at which all of the pieces of header information can be obtained, and thereby acquire the ROHC context information at the timing at which all of the pieces of header information can be obtained. Note that the UE 122 may conform to the parameter related to the timing at which all of the pieces of header information can be obtained in the RRC of the UE 122 to acquire information of the timing at which all of the pieces of header information can be obtained and notify the MAC entity of the UE 122 of information including a part or all of the acquired timing information, and thereby acquire the ROHC context information at the timing at which all of the pieces of header information can be obtained. In a case of notifying the MAC entity of the UE 122 of information including a part or all of the timing information acquired by the RRC of the UE 122, information of the RNTI used for reception of the MBS session using point-to-multipoint connection may be transmitted together. Note that, in the RRC_IDLE state, the RRC_INACTIVE state, or the RRC_CONNECTED state, the UE 122 may perform the processing of acquiring the ROHC context in accordance with the parameter related to the ROHC included in the MBS configuration information message and/or the MBS MTCH parameter for the MBS session of interest. Note that the timing at which all of the pieces of header information can be obtained may be referred to as timing at which the IR state, and/or the FO state, and/or the SO state is used. The timing at which all of the pieces of header information can be obtained may be referred to as timing at which the ROHC context information can be obtained. The timing at which all of the pieces of header information can be obtained may be referred to as timing at which reception of the MBS or the MTCH is started. The timing at which all of the pieces of header information can be obtained may be referred to by another term meaning timing at which all of the pieces of information included in the header (the IP header, the UDP header, the TCP header, the RTP header, or the like) to be subjected to header compression in the ROHC can be obtained. (Step S1206)

In Step S1204, in a case that the processing unit 502 of the UE 122 determines that the ROHC is not applied to the MBS session of interest or determines that acquisition of the ROHC context information is not necessary, the processing unit 502 of the UE 122 may determine that transition to the RRC_CONNECTED state with the purpose of acquisition of the ROHC context information is not necessary. In Step S1204, in a case that the processing unit 502 of the UE 122 determines that the ROHC is not applied to the MBS session of interest or determines that acquisition of the ROHC context information is not necessary, the processing unit 502 of the UE 122 may receive the MBS service without acquiring the ROHC context information in the RRC_IDLE state or the RRC_INNACTIVE state. In Step S1204, in a case that the processing unit 502 of the UE 122 determines that the ROHC is not applied to the MBS session of interest or determines that acquisition of the ROHC context information is not necessary, the processing unit 502 of the UE 122 may receive the MBS service without acquiring the ROHC context information in the RRC_CONNECTED state. (Step S1206)

In Step S1204, the processing unit 502 of the UE 122 may determine whether the parameter related to the Hyper Frame Number (HFN) is included in the MBS configuration information message received in Step S1202 for the MBS session of interest. The parameter related to the HFN may be a parameter related to the HFN that the gNB 108 is to use or is using for MBS session transmission. The parameter related to the HFN may be a parameter indicating that the UE 122 needs to acquire a value of the HFN that the gNB 108 is to use or is using for MBS session transmission. The HFN that the gNB 108 is to use or is using for the MBS session transmission MBS session may be the HFN being a state variable of the transmitting PDCP entity that the gNB 108 is to use or is using for MBS session transmission. In a case that the gNB 108 transmits the MBS configuration information message, the gNB 108 may set the latest value of the HFN of the transmitting PDCP entity that the gNB 108 is to use or is using for MBS session transmission to the parameter related to the HFN. The parameter related to the HFN may be a parameter related to timing at which the value of the HFN is transmitted from the gNB 108 using the MCCH or the MTCH. For example, the timing at which the value of the HFN is transmitted from the gNB 108 using the MCCH or the MTCH may include a part or all of a parameter indicating a period in which the value of the HFN may be changed, a parameter indicating a time interval of transmission of the value of the HFN with the number of radio frames, a parameter indicating an offset of the radio frame in which the value of the HFN is scheduled, a parameter indicating a slot in which the value of the HFN is scheduled, and a parameter indicating a period (window length) of the slot in which the value of the HFN is scheduled. At the timing at which the value of the HFN is transmitted, the gNB 108 may set the latest value of the HFN of the transmitting PDCP entity, or the last value of the HFN used for MBS session transmission, or the value of the HFN used for next MBS session transmission, which the gNB 108 is to use or is using for MBS session transmission, to an RRC message and/or a PDCP control PDU for transmission.

In Step S1204, in a case that the processing unit 502 of the UE 122 determines that the parameter related to the HFN is included in the received MBS configuration information message for the MBS session of interest, the RRC of the UE 122 may acquire the value of the HFN in accordance with the parameter related to the HFN and notify the PDCP entity of the MRB of the UE 122. The RRC of the UE 122 may perform processing so that the PDCP entity of the MRB of the UE 122 can acquire the value of the HFN in accordance with the parameter related to the HFN. The RRC of the UE 122 may acquire information of the timing at which the value of the HFN is transmitted in accordance with the parameter related to the timing at which the value of the HFN is transmitted and notify the MAC entity of the UE 122 of information including a part or all of the acquired timing information, and thereby perform processing so that the PDCP entity of the RRC and/or the MRB of the UE 122 can acquire the value of the HFN at the timing at which the value of the HFN is transmitted. In a case of notifying the MAC entity of the UE 122 of information including a part or all of the timing information acquired by the RRC of the UE 122, information of the RNTI used for reception of the MBS session using point-to-multipoint connection may be transmitted together. The PDCP entity of the MRB of the UE 122 may use the value of the HFN notified from an upper layer or the value of the HFN acquired by receiving the PDCP control PDU as an initial value of the HFN of the receiving PDCP entity. For example, the PDCP entity of the MRB of the UE 122 may use the acquired value of the HFN as an initial value of the HFN part of the state variable indicating the COUNT value of the PDCP SDU expected to be received next. For example, the PDCP entity of the MRB of the UE 122 may use the acquired value of the HFN as an initial value of the HFN part of the state variable indicating the COUNT value of the first PDCP PDU out of the PDCP SDUs that are to be received and have not been delivered to the upper layer.

In Step S1204, in a case that the processing unit 502 of the UE 122 determines that the parameter related to the HFN is included in the received MBS configuration information message for the MBS session of interest, the UE 122 may transition from the RRC_IDLE state or the RRC_INACTIVE state to the RRC_CONNECTED state. The RRC of the UE 122 in the RRC_CONNECTED state may receive an RRC message including the value of the HFN from the gNB 108 via the DCCH, and thereby acquire the value of the HFN. The RRC of the UE 122 may notify the PDCP entity of the MRB of the UE 122 of the acquired value of the HFN. The PDCP entity of the MRB of the UE 122 may use the value of the HFN notified from an upper layer as an initial value of the HFN of the receiving PDCP entity. For example, the PDCP entity of the MRB of the UE 122 may use the acquired value of the HFN as an initial value of the HFN part of the state variable indicating the COUNT value of the PDCP SDU expected to be received next. For example, the PDCP entity of the MRB of the UE 122 may use the acquired value of the HFN as an initial value of the HFN part of the state variable indicating the COUNT value of the first PDCP PDU out of the PDCP SDUs that are to be received and have not been delivered to the upper layer.

In Step S1204, the processing unit 502 of the UE 122 may determine whether the parameter related to COUNT is included in the MBS configuration information message received in Step S1202 for the MBS session of interest. The parameter related to COUNT may be a parameter related to the COUNT value that the gNB 108 is to use or is using for MBS session transmission. The parameter related to COUNT may be a parameter indicating that the UE 122 needs to acquire a value of COUNT that the gNB 108 is to use or is using for MBS session transmission. The COUNT value that the gNB 108 is to use or is using for the MBS session transmission MBS session may be the COUNT value being a state variable of the transmitting PDCP entity that the gNB 108 is to use or is using for MBS session transmission. In a case that the gNB 108 transmits the MBS configuration information message, the gNB 108 may set the latest value of the COUNT value of the transmitting PDCP entity that the gNB 108 is using for MBS session transmission to the parameter related to COUNT. The parameter related to COUNT may be a parameter related to timing at which the COUNT value is transmitted from the gNB 108 using the MCCH or the MTCH. For example, the timing at which the COUNT value is transmitted from the gNB 108 using the MCCH or the MTCH may include a part or all of a parameter indicating a period in which the COUNT value may be changed, a parameter indicating a time interval of transmission of the COUNT value with the number of radio frames, a parameter indicating an offset of the radio frame in which the COUNT value is scheduled, a parameter indicating a slot in which the COUNT value is scheduled, and a parameter indicating a period (window length) of the slot in which the COUNT value is scheduled. At the timing at which the COUNT value is transmitted, the gNB 108 may set the latest value of the COUNT value of the transmitting PDCP entity, or the last COUNT value used for MBS session transmission, or the COUNT value used for next MBS session transmission, which the gNB 108 is to use or is using for MBS session transmission, to an RRC message and/or a PDCP control PDU for transmission.

In Step S1204, in a case that the processing unit 502 of the UE 122 determines that the parameter related to COUNT is included in the received MBS configuration information message for the MBS session of interest, the RRC of the UE 122 may acquire the COUNT value in accordance with the parameter related to COUNT and notify the PDCP entity of the MRB of the UE 122. The RRC of the UE 122 may perform processing so that the PDCP entity of the MRB of the UE 122 can acquire the COUNT value in accordance with the parameter related to COUNT. The RRC of the UE 122 may acquire information of the timing at which the COUNT value is transmitted in accordance with the parameter related to the timing at which the COUNT value is transmitted and notify the MAC entity of the UE 122 of information including a part or all of the acquired timing information, and thereby perform processing so that the PDCP entity of the RRC and/or the MRB of the UE 122 can acquire the COUNT value at the timing at which the COUNT value is transmitted. In a case of notifying the MAC entity of the UE 122 of information including a part or all of the timing information acquired by the RRC of the UE 122, information of the RNTI used for reception of the MBS session using point-to-multipoint connection may be transmitted together. The PDCP entity of the MRB of the UE 122 may use the COUNT value notified from an upper layer or acquired by receiving the PDCP control PDU, or a value obtained by incrementing the acquired COUNT value by 1 (integer value of 1) as an initial value of the COUNT value of the receiving PDCP entity.

In Step S1204, in a case that the processing unit 502 of the UE 122 determines that the parameter related to COUNT is included in the received MBS configuration information message for the MBS session of interest, the UE 122 may transition from the RRC_IDLE state or the RRC_INACTIVE state to the RRC_CONNECTED state. The RRC of the UE 122 in the RRC_CONNECTED state may receive an RRC message including the COUNT value from the gNB 108 via the DCCH, and thereby acquire the COUNT value. The RRC of the UE 122 may notify the PDCP entity of the MRB of the UE 122 of the acquired COUNT value. The PDCP entity of the MRB of the UE 122 may use the COUNT value notified from an upper layer or the value obtained by incrementing the acquired COUNT value by 1 (integer value of 1) as an initial value of the COUNT value of the receiving PDCP entity.

In Step S1204, the PDCP entity of the MRB of the UE 122 may use the COUNT value notified from an upper layer, the COUNT value acquired by receiving the PDCP control PDU, or the value obtained by incrementing the acquired COUNT value by 1 (integer value of 1) as an initial value of the state variable indicating the COUNT value of the PDCP SDU expected to be received next on a receiving side of the PDCP entity. The PDCP entity of the MRB of the UE 122 may use the COUNT value notified from an upper layer, the COUNT value acquired by receiving the PDCP control PDU, the value obtained by incrementing the acquired COUNT value by 1 (integer value of 1), or a value obtained by subtracting a certain value from the acquired COUNT value as an initial value of the state variable indicating the COUNT value of the first PDCP PDU out of the PDCP SDUs that are to be received and have not been delivered to the upper layer on a receiving side of the PDCP entity. The value obtained by subtracting a certain value from the acquired COUNT value may be a value obtained by subtracting a half value of a window size from the acquired COUNT value. In a case that the PDCP entity of the MRB of the UE 122 uses the COUNT value notified from an upper layer, the COUNT value acquired by receiving the PDCP control PDU, or the value obtained by incrementing the acquired COUNT value by 1 (integer value of 1) as an initial value of the COUNT value of the receiving PDCP entity, the COUNT value may be separated into the HFN part and the Sequence Number (SN) part to be used as the initial value.

In Step S1204, in a case that the processing unit 502 of the UE 122 determines that the parameter related to the HFN is not included for the MBS session of interest, and/or determines that the parameter related to COUNT is not included for the MBS session of interest, the processing unit 502 of the UE 122 may determine that transition to the RRC_CONNECTED state with the purpose of acquisition of the value of the HFN and/or acquisition of the COUNT value is not necessary. In Step S1204, in a case that the processing unit 502 of the UE 122 determines that the parameter related to the HFN is not included for the MBS session of interest, and/or determines that the parameter related to COUNT is not included for the MBS session of interest, the processing unit 502 of the UE 122 may receive the MBS service without acquiring the value of the HFN and/or the COUNT value in the RRC_IDLE state or the RRC_INNACTIVE state. In Step S1204, in a case that the processing unit 502 of the UE 122 determines that the parameter related to the HFN is not included for the MBS session of interest, and/or determines that the parameter related to COUNT is not included for the MBS session of interest, the processing unit 502 of the UE 122 may receive the MBS service without acquiring the value of the HFN and/or the COUNT value in the RRC_CONNECTED state. (Step S1206)

In Step S1204, the processing unit 502 of the UE 122 may determine whether the parameter related to a timer of the status report is included in the MBS configuration information message received in Step S1202 for the MBS session of interest. The parameter related to a timer of the status report may be a value of a timer used for PDCP status report transmission. In a case that the parameter related to a timer of the status report is included in the received MBS configuration information message for the MBS session of interest, the processing unit 502 of the UE 122 may configure the value of the timer used for PDCP status report transmission being received. The timer used for PDCP status report transmission may be used by the PDCP entity of the UE 122 to detect the PDCP PDU or loss of the PDCP PDU. The timer used for PDCP status report transmission may be only one timer that runs for each PDCP entity. The timer used for PDCP status report transmission may be started or restarted in a case that the UE 122 detects the PDCP PDU or loss of the PDCP PDU. For example, the timer used for PDCP status report transmission may be started or restarted, based on satisfaction of a condition including that the timer used for PDCP status report transmission is not running, and/or that the state variable (for example, the state variable referred to as RX_NEXT) indicating the COUNT value of the PDCP SDU expected to be received next is larger than the state variable (for example, the state variable referred to as RX_DELIV) indicating the COUNT value of the first PDCP PDU out of the PDCP SDUs that are to be received and have not been delivered to the upper layer, in a case that the PDCP of the UE 122 receives the PDCP data PDU from a lower layer. The timer used for PDCP status report transmission may be stopped and/or reset in a case that the UE 122 no longer has the PDCP PDU or loss of the PDCP PDU. For example, the timer used for PDCP status report transmission may be stopped and/or reset based on that the timer used for PDCP status report transmission is running, and/or that the state variable (for example, the state variable referred to as RX_NEXT) indicating the COUNT value of the PDCP SDU expected to be received next is equal to the state variable (for example, the state variable referred to as RX_DELIV) indicating the COUNT value of the first PDCP PDU out of the PDCP SDUs that are to be received and have not been delivered to the upper layer. The expression “equal to” may be replaced with “larger than or equal to”. The expression “equal to” may be replaced with “smaller than or equal to”. Based on that the timer used for PDCP status report transmission has expired, the status report of the PDCP entity of the MRB may be triggered. The timer used for PDCP status report transmission may be stopped and/or reset, based on that the PDCP entity is requested to be suspended from an upper layer. The timer used for PDCP status report transmission may be stopped and/or reset, based on that the PDCP entity is requested to be re-established from an upper layer. The timer used for PDCP status report transmission may be stopped and/or reset, based on that the PDCP entity is requested to be reconfigured from an upper layer.

Note that the MRB may be established and/or configured for each MBS session in which the UE 122 is interested. In a case that multiple MRBs are established and/or configured for the UE 122, regarding the processing in Step S1204, the processing may be performed for a corresponding MRB.

In Step S1206, before starting reception of the MBS session of interest, in order to start reception of the MBS session of interest, the processing unit 502 of the UE 122 may perform processing of establishing one or multiple MRBs. For example, the MRB establishment processing may be triggered based on a case of starting the MBS session, a case that the UE 122 enters a cell where the MBS service in which the UE 122 is interested is provided via the MRB, a case of starting to take an interest in the MBS service, a case that a restriction on a UE capability that has restricted reception of the MBS service is removed, and the like. The MRB establishment processing may be performed in a case that the UE 122 is in the RRC_IDLE state, may be performed in a case that the UE 122 is in the RRC_INACTIVE state, or may be performed in a case that the UE 122 is in the RRC_CONNECTED state. The MRB establishment processing may be triggered based on that an RRC message indicating establishment of the MRB is received or has been received from the gNB 108 via the DCCH in a case that the UE 112 is in the RRC_CONNECTED state. The RRC message indicating establishment of the MRB may include a part or all of the parameters included in the MBS configuration information message in Step S1202 described above. The processing unit 502 of the UE 122 may perform the MRB establishment processing by using configuration information including a part or all of default configuration information for each entity stored by the UE 122, a parameter related to the MBS configuration included in the MBS configuration information message received via the MCCH in Step S1202, and a parameter related to the MBS configuration included in the RRC message indicating establishment of the MRB received via the DCCH.

In a case of performing the MRB establishment processing, the processing unit 502 of the UE 122 may perform a part or all of the following processing of (A) to (M):
(A) in a case that the SDAP entity is not present in the PDU session providing the MBS and/or the PDU session corresponding to the parameter indicating the PDU session included in the parameter related to the MBS configuration, establish and/or configure the SDAP entity;
(B) establish the PDCP entity in accordance with a default configuration related to MRB establishment or in accordance with a configuration received from the gNB 108;
(C) establish and/or configure the RLC entity in accordance with a default configuration related to MRB establishment or a configuration received from the base station;
(D) establish and/or configure the RLC entity of the RLC bearer that receives the MBS using point-to-multipoint connection in accordance with a default configuration related to MRB establishment or a configuration received from the base station;
(E) configure a logical channel of the RLC bearer that receives the MBS using point-to-multipoint connection for the MAC entity in accordance with a default configuration related to MRB establishment or a configuration received from the base station;
(F) associate the RLC bearer or the logical channel of the RLC bearer established and/or configured in processing (D) and/or processing (E) with the PDCP entity established and/or configured in processing (B);
(G) establish and/or configure the RLC entity of the RLC bearer that receives the MBS using point-to-point connection in accordance with a default configuration related to MRB establishment or a configuration received from the base station;
(H) configure a logical channel of the RLC bearer that receives the MBS using point-to-point connection for the MAC entity in accordance with a default configuration related to MRB establishment or a configuration received from the base station;
(I) associate the RLC bearer or the logical channel of the RLC bearer established and/or configured in processing (G) and/or processing (H) with the PDCP entity established and/or configured in processing (B);
(J) associate the SDAP entity and the established MRB;
(K) notify an upper layer of information including a part or all of the TMGI, the Session ID, the PDU session ID, and the QoS flow corresponding to the established MRB, and thereby notify the upper layer of establishment of the MRB;
(L) in a case that disabling of a ciphering function (ciphering disabled) is not configured for the PDCP entity of the MRB, configure a ciphering algorithm for the PDCP entity established in processing (B), and apply a master key or a secondary key in accordance with a parameter indicating whether to use the master key or use the secondary key;
(M) in a case that integrity protection is configured for the PDCP entity of the MRB, configure an integrity protection algorithm for the PDCP entity established in processing (B), and apply a master key or a secondary key in accordance with a parameter indicating whether to use the master key or use the secondary key.

In a case that the PDCP status report is triggered in the PDCP entity of one or multiple MRBs, the processing unit 502 of the UE 122 that has established one or multiple MRBs may create the PDCP status report and transmit the PDCP status report to the gNB 108. In a case that the processing unit 502 of the UE 122 creates the PDCP status report in the PDCP entity of the MRB, the processing unit 502 may submit the created PDCP status report to the RLC entity of the RLC bearer that receives the MBS using point-to-point connection being associated with the PDCP entity of the MRB, and need not submit the created PDCP status report to the RLC entity of the RLC bearer that receives the MBS using point-to-multipoint connection being associated with the PDCP entity of the MRB. The expression “the created PDCP status report may be submitted to the RLC entity of the RLC bearer that receives the MBS using point-to-point connection being associated with the PDCP entity of the MRB, and need not be submitted to the RLC entity of the RLC bearer that receives the MBS using point-to-multipoint connection being associated with the PDCP entity of the MRB” may be replaced with an expression “the created PDCP status report may be submitted only to the RLC entity of the RLC bearer that receives the MBS using point-to-point connection being associated with the PDCP entity of the MRB”. Note that the trigger of PDCP reporting in the PDCP entity of the MRB may be performed only for the MRB for which transmission of the PDCP status report is configured by the upper layer. (Step S1208)

In Step S1208, in a case that the PDCP status report is triggered in the PDCP entity of one or multiple MRBs, the processing unit 502 of the UE 122 may determine whether the RLC bearer that receives the MBS using point-to-point connection is associated with the PDCP entity of the MRB, and based on that the RLC bearer that receives the MBS using point-to-point connection is associated therewith, the processing unit 502 may create the PDCP status report and submit the created status report only to the RLC entity of the RLC bearer that receives the MRB using point-to-point connection. In a case that the PDCP status report is triggered in the PDCP entity of the MRB, the processing unit 502 of the UE 122 may determine whether the RLC bearer that receives the MBS using point-to-point connection is associated with the PDCP entity of the MRB, and based on that the RLC bearer that receives the MBS using point-to-point connection is not associated therewith, the processing unit 502 need not create the PDCP status report.

In Step S1208, in a case that the PDCP status report is triggered in the PDCP entity of one or multiple MRBs, the processing unit 502 of the UE 122 may create the PDCP status report and determine whether the RLC bearer that receives the MBS using point-to-point connection is associated with the PDCP entity of the MRB, and based on that the RLC bearer that receives the MBS using point-to-point connection is associated therewith, the processing unit 502 may submit the created PDCP status report only to the RLC entity of the RLC bearer that receives the MRB using point-to-point connection. In a case that the PDCP status report is triggered in the PDCP entity of the MRB, the processing unit 502 of the UE 122 may create the PDCP status report and determine whether the RLC bearer that receives the MBS using point-to-point connection is associated with the PDCP entity of the MRB, and based on that the RLC bearer that receives the MBS using point-to-point connection is not associated therewith, the processing unit 502 need not submit the created PDCP status report to a lower layer. In a case that the PDCP status report is triggered in the PDCP entity of the MRB, the processing unit 502 of the UE 122 may create the PDCP status report and determine whether the RLC bearer that receives the MBS using point-to-point connection is associated with the PDCP entity of the MRB, and based on that the RLC bearer that receives the MBS using point-to-point connection is not associated therewith, the processing unit 502 may discard the created PDCP status report.

The RLC entity of the RLC bearer that receives the MBS using point-to-point connection may be the AM RLC entity. The RLC entity with which the RLC bearer that receives the MBS using point-to-point connection is associated may be the bi-directional UM RLC entity. The RLC entity with which the RLC bearer that receives the MBS using point-to-point connection is associated may be the transmitting UM RLC entity and/or the receiving UM RLC entity of the uni-directional UM RLC entity.

In Step S1208, the trigger of the PDCP status report may be performed based on that transmission of the PDCP status report is requested from the RRC layer or an upper layer. The expression “transmission of the PDCP status report is requested from the RRC layer or an upper layer” may be equivalent to an expression “PDCP data recovery is requested from the RRC layer or an upper layer”. In Step S1208, the trigger of the PDCP status report may be performed based on that one or multiple RLC bearers associated with the PDCP entity of the MRB have been released, or suspended, or deactivated. In Step S1208, the trigger of the PDCP status report may be performed based on that the timer of the status report configured in Step S1204 has expired in the PDCP entity. In Step S1208, the trigger of the PDCP status report may be performed based on that the RLC bearer that receives the MRB has been switched. The expression “the RLC bearer that receives the MRB has been switched” may be equivalent to an expression “the RLC bearer that receives the MRB has been switched from the RLC bearer that receives the MBS using point-to-multipoint connection to the RLC bearer that receives the MBS using point-to-point connection”. The expression “the RLC bearer that receives the MRB has been switched” may be equivalent to an expression “the RLC bearer that receives the MRB has been switched from the RLC bearer that receives the MBS using point-to-point connection to the RLC bearer that receives the MBS using point-to-multipoint connection”.

In Step S1208, in a case that a parameter indicating a request for PDCP status report transmission to one or multiple MRBs of the UE 122 is included in an RRC message that the UE 122 receives from the gNB 108, the processing unit 502 of the UE 122 may request transmission of the PDCP status report from the RRC of the UE 122 to the PDCP layer of the MRB of the UE 122. Note that the RRC message may be an RRC message transmitted via the DCCH, or may be an RRC message transmitted via the MCCH. The parameter indicating a request for PDCP status report transmission to one or multiple MRBs may include a part or all of the identifier for identifying the MRB and the parameter related to the information of the MBS session. In Step S1208, in a case that the UE 122 receives the RRC message indicating a request for PDCP status report transmission from the gNB 108, the processing unit 502 of the UE 122 may request transmission of the PDCP status report from the RRC of the UE 122 to the PDCP layer of the MRB of the UE 122. Note that the RRC message indicating a request for PDCP status report transmission may be an RRC message transmitted via the DCCH, or may be an RRC message transmitted via the MCCH. The RRC message indicating a request for PDCP status report transmission may include a part or all of the identifier for identifying the MRB and the parameter related to the information of the MBS session.

In Step S1208, based on reception of an RRC message (counter check message) for counter check from the gNB 108 to one or multiple MRBs of the UE 122, the processing unit 502 of the UE 122 may perform counter check processing, set results to an RRC message (counter check response message) for a counter check response, and report the results to the gNB 108. The RRC message for the counter check may include a part or all of the identifier for identifying the MRB, the parameter related to the information of the MBS session, and a Most Significant Bits (MSB) value of the COUNT value in the uplink direction and/or the downlink direction associated with the MRB. The RRC message for the counter check may be a message for causing notification of the MSB value of the current COUNT value associated with the MSB of the gNB 108 from the gNB 108 to the UE 122, and thereby requesting reporting of results of comparison with the MSB value of the current COUNT value associated with the MSB of the UE 122 from the UE 122 to the gNB 108. In the counter check processing, the processing unit 502 of the UE 122 may perform processing including a part or all of the following processing of (A) to (D) for the MRB established for the UE 122:
(A) in a case that the MRB is the uni-directional bearer and COUNT for the uplink direction and/or the downlink direction is not present, assume the COUNT value in the direction without the COUNT value as ‘0’;
(B) for the MRB in which the identifier for identifying the MRB and/or the parameter related to the information of the MBS session is not included in the RRC message for the counter check, set the COUNT value for the uplink direction and/or the downlink direction stored by the UE 122 to the RRC message for the counter check response;
(C) for the MRB in which the MSB value of the COUNT value in the uplink direction and/or the downlink direction is included in the RRC message for the counter check, in a case that the received MSB value of the COUNT value in the uplink direction and/or the downlink direction is different from the COUNT value in the uplink direction and/or the downlink direction stored by the UE 122, set the COUNT value for the uplink direction and/or the downlink direction stored by the UE 122 to the RRC message for the counter check response;
(D) for the MRB in which the identifier for identifying the MRB and/or the parameter related to the information of the MBS session is included in the RRC message for the counter check, set the COUNT value for the uplink direction and/or the downlink direction stored by the UE 122 to the RRC message for the counter check response.

FIG. 13 is a diagram illustrating an example of a processing method of the terminal apparatus according to an embodiment of the present invention. With reference to FIG. 13, a maintaining method for some of the state variables in the PDCP entity and/or the RLC entity in a case that the UE 122 receives the MBS session using the MRB will be described.

As illustrated in FIG. 13, the processing unit 502 of the UE 122 may determine a type of data to be received or data that has been received from the gNB 108. The type of the data may be a type of service to which the data belongs. The type of the data may be a type of logical channel on which the data is transmitted. The type of the data may be a type of transmission method of the data. For example, the transmission method of the data may be a method of transmitting the data using point-to-point connection, or may be a method of transmitting the data using point-to-multipoint connection. The type of the data may be referred to as a type of radio bearer that receives the data. The type of the data may be referred to as a type of RLC bearer that receives the data. (Step S1300)

In Step S1300, the processing unit 502 of the UE 122 may determine whether or not it is reception of MBS data. In Step S1300, the processing unit 502 of the UE 122 may determine whether or not it is point-to-multipoint reception of MBS data.

The processing unit 502 of the UE 122 may maintain the state variable in the PDCP entity and/or the RLC entity. In the PDCP entity and/or the RLC entity, in a case of maintaining the state variable, the state variable may be maintained based on the determination of Step S1300. (Step S1302)

In Step S1302, for example, the processing unit 502 of the UE 122 may maintain the state variable indicating the COUNT value of the PDCP SDU expected to be received next in the receiving PDCP entity. Next, in maintaining of the state variable indicating the COUNT value of the PDCP SDU expected to be received, the processing unit 502 of the UE 122 may perform processing including a part or all of the following processing of (A) to (C):
(A) based on that it is reception of the MBS data, set an initial value of the sequence number part of the state variable indicating the COUNT value of the PDCP SDU expected to be received next as a first value;
(B) based on that it is reception of the MBS data, set an initial value of the HFN part of the state variable indicating the COUNT value of the PDCP SDU expected to be received next as the value of the HFN acquired in Step S1204 or a certain integer value;
(C) based on that it is at least not reception of the MBS data, set an initial value of the state variable indicating the COUNT value of the PDCP SDU expected to be received next as 0 (integer value of 0).

Note that the first value may be a value obtained by incrementing the sequence number of the PDCP data PDU received first by 1. The first value may be an absolute value of a value obtained by incrementing the sequence number of the PDCP data PDU received first by 1 (integer value of 1). The first value may be a remainder obtained by dividing the value obtained by incrementing the sequence number of the PDCP data PDU received first by 1 by a second value. The second value may be 2 (integer value of 2) to the power of a third value. The third value may be a downlink PDCP sequence number size. Note that the state variable indicating the COUNT value of the PDCP SDU expected to be received next may be a state variable referred to as RX_NEXT.

In Step S1302, for example, the processing unit 502 of the UE 122 may maintain the state variable indicating the COUNT value of the first PDCP PDU out of the PDCP SDUs that are to be received and have not been delivered to the upper layer in the receiving PDCP entity. In maintaining of the state variable indicating the COUNT value of the first PDCP PDU out of the PDCP SDUs that are to be received and have not been delivered to the upper layer, the processing unit 502 of the UE 122 may perform processing including a part or all of the following processing of (D) to (F):
(D) based on that it is reception of the MBS data, set an initial value of the sequence number part of the state variable indicating the COUNT value of the first PDCP PDU out of the PDCP SDUs that are to be received and have not been delivered to the upper layer as a fourth value;
(E) based on that it is reception of the MBS data, set an initial value of the HFN part of the state variable indicating the COUNT value of the first PDCP PDU out of the PDCP SDUs that are to be received and have not been delivered to the upper layer as the value of the HFN acquired in Step S1204 or a certain integer value;
(F) based on that it is at least not reception of the MBS data, set an initial value of the state variable indicating the COUNT value of the first PDCP PDU out of the PDCP SDUs that are to be received and have not been delivered to the upper layer as 0 (integer value of 0).

Note that the fourth value may be a value equal to the first value. The fourth value may be a value smaller than the first value. The fourth value may be an absolute value of a value obtained by subtracting a fifth value from the sequence number of the PDCP data PDU received first. The fifth value may be a certain value. The fifth value may be a half value of a Window Size. The window size may be a half value of the second value. In other words, the window size may be a half value of 2 (integer value of 2) to the power of a downlink PDCP sequence number size. The half value may be a value obtained by multiplying 0.5, or may be a value obtained by multiplying 2 (integer value of 2) to the power of minus 1 (integer value of −1). The fourth value may be a remainder obtained by dividing the value obtained by subtracting the fifth value from the sequence number of the PDCP data PDU received first by the second value. In other words, the fourth value may be a remainder obtained by dividing the value obtained by subtracting the fifth value from the sequence number of the PDCP data PDU received first by 2 (integer value of 2) to the power of a downlink PDCP sequence number size. Note that the state variable indicating the COUNT value of the first PDCP PDU out of the PDCP SDUs that are to be received and have not been delivered to the upper layer may be a state variable referred to as RX_DELIV.

Note that, in Step S1302 described above, the downlink PDCP sequence number size may be a parameter included in the PDCP configuration information element. The downlink PDCP sequence number size may be configured to 12 (integer value of 12), 18 (integer value of 18), or another value in a case that the PDCP entity is established and/or configured.

In Step S1302, for example, the processing unit 502 of the UE 122 may maintain a state variable indicating the highest sequence number out of the sequence numbers of the received UMD PDU in the UM RLC entity. In maintaining of the state variable indicating the highest sequence number out of the sequence numbers of the received UMD PDU, the processing unit 502 of the UE 122 may perform processing including a part or all of the following processing of (G) to (H):
(G) based on that it is point-to-multipoint reception of the MBS data, set an initial value of the state variable indicating the highest sequence number out of the sequence numbers of the received UMD PDU as a value of the sequence number of the UMD PDU that satisfies a first condition received first;
(H) based on that it is at least not point-to-multipoint reception of the MBS data, set an initial value of the state variable indicating the highest sequence number out of the sequence numbers of the received UMD PDU as 0 (integer value of 0).

Note that the state variable indicating the highest sequence number out of the sequence numbers of the received UMD PDU may be a state variable referred to as RX_Next_Highest.

In Step S1302, for example, the processing unit 502 of the UE 122 may maintain a state variable indicating the earliest sequence number, whose reassembly is considered in the UM RLC entity. In maintaining of the state variable indicating the earliest sequence number whose reassembly is considered, the processing unit 502 of the UE 122 may perform processing including a part or all of the following processing of (I) to (J):
(I) based on that it is point-to-multipoint reception of the MBS data, set an initial value of the state variable indicating the earliest sequence number whose reassembly is considered as a value of the sequence number of the UMD PDU that satisfies a first condition received first,
(J) based on that it is at least not point-to-multipoint reception of the MBS data, set an initial value of the state variable indicating the earliest sequence number whose reassembly is considered as 0 (integer value of 0).

Note that the state variable indicating the earliest sequence number whose reassembly is considered may be a state variable referred to as RX_Next_Reassembly.

Note that, in Step S1302 described above, the UMD PDU that satisfies the first condition may be a UMD PDU including a sequence number. The UMD PDU including the sequence number may be a UMD PDU segmented in the transmitting UM RLC entity.

Note that, in Step S1300 and/or Step S1302 described above, the point-to-multipoint reception of the MBS data may be referred to as point-to-multipoint reception of the MBS. The point-to-multipoint reception of the MBS data may be referred to as the MRB that receives the MBS using point-to-multipoint connection. The point-to-multipoint reception of the MBS data may be referred to as point-to-multipoint reception in the MRB. The point-to-multipoint reception of the MBS data may be referred to as the RLC bearer of the MRB configured to receive the MBS using point-to-multipoint connection. The point-to-multipoint reception of the MBS data may be referred to as point-to-multipoint reception in the RLC bearer of the MRB. The point-to-multipoint reception of the MBS data may be referred to as reception of the MBS data. The reception of the MBS data may be referred to as MBS reception. The reception of the MBS data may be referred to as the MBS. The reception of the MBS data may be referred to as being the MRB. The reception of the MBS data may be referred to as the MRB. The reception of the MBS data may be referred to as reception in the MRB. The point-to-multipoint reception of the MBS data may be referred to using another expression meaning reception of the MBS session using point-to-multipoint connection. The point-to-multipoint reception of the MBS data may be referred to using another expression meaning reception of the MBS session using point-to-multipoint connection, using the MRB, the RLC bearer of the MRB, or the like. The point-to-multipoint reception of the MBS data may be referred to using another expression meaning the radio bearer that receives the MBS session using point-to-multipoint connection, or the RLC bearer that receives the MBS session using point-to-multipoint connection. The reception of the MBS data may be referred to using another expression meaning reception of the MBS session.

The reception of the MBS data may be referred to using another expression meaning reception of the MBS session, using the MRB, the RLC bearer of the MRB, or the like. The reception of the MBS data may be referred to using another expression meaning the radio bearer that receives the MBS session, or the RLC bearer that receives the MBS session.

Note that, in the above description, the MBS session of interest may be referred to as the MBS session. In the above description, the value of the HFN may be referred to as the Most Significant Bits (MSB) value of the COUNT value. In the above description, the HFN may be referred to as the Most Significant Bits (MSB) of COUNT.

Note that, in the above description, the RLC bearer that receives the MBS using point-to-point connection may be the RLC bearer that transmits feedback for the MBS to the gNB 108.

Note that, in the above description, the RLC bearer may be referred to as the RLC entity. In the above description, the RLC bearer may be referred to as the logical channel.

Note that, in the above description, the PDCP entity may be the receiving PDCP entity and/or the transmitting PDCP entity.

Note that, in the above description, the RLC entity may be the UM RLC entity and/or the AM RLC entity and/or the TM RLC entity.

Note that, in the above description, the ROHC may be referred to as Ethernet Header Compression (EHC).

As described above, in an embodiment of the present invention, the terminal apparatus can maintain the state variables in the PDCP entity and/or the RLC entity even in multicasting, and therefore the terminal apparatus, the base station apparatus, and the method that can efficiently control the MBS by using NR can be provided.

The radio bearer in the above description may be a part or all of the DRB, the SRB, and the MRB.

In the above description, expressions such as “link”, “map”, and “associate” may be replaced with each other.

In the above description, “the” may be replaced with “above-described”.

In the above description, the “SpCell of the SCG” may be replaced with the “PSCell”.

In the example of each processing or the example of the flow of each processing in the above description, a part or all of the steps need not be performed. In the example of each processing or the example of the flow of each processing in the above description, order of the steps may be different from each other. In the example of each processing or the example of the flow of each processing in the above description, a part or all of the processing in each step need not be performed. In the example of each processing or the example of the flow of each processing in the above description, order of processing in each step may be different from each other. In the above description, “to perform B based on satisfaction of A” may be replaced with “to perform B”. In other words, “to perform B” may be performed independently of “satisfaction of A”.

Note that in the above description, “A may be interpreted as B” may include the meaning that B is interpreted as A in addition to interpretation of A as B. In a case that the above description contains “C may be D” and “C may be E,” this means inclusion of “D may be E.” In a case that the above description contains “F may be G” and “G may be H,” this means inclusion of “F may be H.”

In the above description, in a case that a condition “A” and a condition “B” are conflicting conditions, the condition “B” may be expressed as “other” condition of the condition “A”.

Various aspects of the terminal apparatus according to embodiments of the present invention will be described below.

(1) Provided is a terminal apparatus for communicating with a base station apparatus. The terminal apparatus includes: a receiver configured to receive data from the base station apparatus; and a processing unit. The processing unit maintains a first state variable in a receiving PDCP entity of the terminal apparatus, and performs processing of, in the maintaining, setting, based on a fact that the data to be received from the base station apparatus is data of an MBS, an initial value of a sequence number part of the first state variable as a first value, and setting, based on a fact that the data to be received from the base station apparatus is at least not the data of the MBS, the initial value of the first state variable to 0. The first state variable is a state variable indicating a COUNT value of a PDCP SDU expected to be received next. The first value is a remainder obtained by dividing, by a second value, a value obtained by incrementing 1 to a sequence number of a PDCP data PDU received first. The second value is 2 to the power of a third value. The third value is a downlink PDCP sequence number size.

(2) Provided is a base station apparatus for communicating with a terminal apparatus. The base station apparatus includes: a transmitter configured to transmit data to the terminal apparatus; and a processing unit. The processing unit maintains, in a receiving PDCP entity of the terminal apparatus, a first state variable, based on the data to be transmitted to the terminal apparatus, and performs processing of, in the maintaining, setting based on a fact that the data to be transmitted to the terminal apparatus is data of an MBS, an initial value of a sequence number part of the first state variable as a first value and setting, based on a fact that the data to be transmitted to the terminal apparatus is at least not the data of the MBS, the initial value of the first state variable to 0. The first state variable is a state variable indicating a COUNT value of a PDCP SDU expected to be received by the terminal apparatus next. The first value is a remainder obtained by dividing, by a second value, a value obtained by incrementing 1 to a sequence number of a PDCP data PDU received first by the terminal apparatus. The second value is 2 to the power of a third value. The third value is a downlink PDCP sequence number size.

(3) Provided is a method of a terminal apparatus for communicating with a base station apparatus. The method includes receiving data from the base station apparatus, maintaining a first state variable in a receiving PDCP entity of the terminal apparatus, and performing processing of, in the maintaining, setting, based on a fact that the data to be received from the base station apparatus is data of an MBS, an initial value of a sequence number part of the first state variable as a first value and setting, based on a fact that the data to be received from the base station apparatus is at least not the data of the MBS, the initial value of the first state variable to 0. The first state variable is a state variable indicating a COUNT value of a PDCP SDU expected to be received next. The first value is a remainder obtained by dividing, by a second value, a value obtained by incrementing 1 to a sequence number of a PDCP data PDU received first. The second value is 2 to the power of a third value. The third value is a downlink PDCP sequence number size.

(4) Provided is a method of a base station apparatus for communicating with a terminal apparatus. The method includes transmitting data to the terminal apparatus, maintaining, in a receiving PDCP entity of the terminal apparatus, a first state variable, based on the data to be transmitted to the terminal apparatus, and performing processing of, in the maintaining, setting, based on a fact that the data to be transmitted to the terminal apparatus is data of an MBS, an initial value of a sequence number part of the first state variable as a first value and setting, based on a fact that the data to be transmitted to the terminal apparatus is at least not the data of the MBS, the initial value of the first state variable to 0. The first state variable is a state variable indicating a COUNT value of a PDCP SDU expected to be received by the terminal apparatus next. The first value is a remainder obtained by dividing, by a second value, a value obtained by incrementing 1 to a sequence number of a PDCP data PDU received first by the terminal apparatus. The second value is 2 to the power of a third value. The third value is a downlink PDCP sequence number size.

A program running on an apparatus according to an aspect of the present invention may serve as a program that controls a Central Processing Unit (CPU) and the like to cause a computer to operate in such a manner as to implement the functions of the above-described embodiments according to the aspect of the present invention. Programs or the information handled by the programs are temporarily loaded into a volatile memory such as a Random Access Memory (RAM) while being processed, or stored in a non-volatile memory such as a flash memory, or a Hard Disk Drive (HDD), and then read, modified, and written by the CPU, as necessary.

Note that the apparatuses in the above-described embodiment may be partially enabled by a computer. In such a case, a program for implementing such control functions may be recorded on a computer-readable recording medium to cause a computer system to read and execute the program recorded on this recording medium. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the above-described program may be configured to realize some of the functions described above, and additionally may be configured to realize the functions described above, in combination with a program already recorded in the computer system.

Furthermore, each functional block or various characteristics of the apparatuses used in the above-described embodiments may be implemented or performed with an electric circuit, that is, typically an integrated circuit or multiple integrated circuits. An electric circuit designed to perform the functions described in the present specification may include a general-purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or the processor may be a processor of known type, a controller, a micro-controller, or a state machine instead. The general-purpose processor or the above-mentioned circuits may include a digital circuit, or may include an analog circuit. Furthermore, in a case that with advances in semiconductor technology, a circuit integration technology appears that replaces the present integrated circuits, it is also possible to use an integrated circuit based on the technology.

Note that, the invention of the present application is not limited to the above-described embodiments. Although apparatuses have been described as an example in the embodiment, the invention of the present application is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope that does not depart from the gist of the present invention. For an aspect of the present invention, various modifications are possible within the scope of the claims, and embodiments that are made by suitably combining technical means disclosed according to the different embodiments are also included in the technical scope of the present invention. In addition, a configuration in which components, which are described in the embodiment described above, having similar effects are interchanged is also included in the present invention.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

100 E-UTRA
102 eNB
104 EPC
106 NR
108 gNB
110 5GC
112, 114, 116, 118, 120, 124 Interface
122 UE
200, 300 PHY
202, 302 MAC
204, 304 RLC
206, 306 PDCP
208, 308 RRC
310 SDAP
210, 312 NAS
500, 604 Receiver
502, 602 Processing unit
504, 600 Transmitter

1. A terminal apparatus for communicating with a base station apparatus, the terminal apparatus comprising:
a receiver configured to receive data from the base station apparatus; and
processing circuitry, wherein
the processing circuitry maintains a first state variable in a receiving PDCP entity of the terminal apparatus,
the processing circuitry performs processing of, in the maintaining,
setting, based on a fact that the data to be received from the base station apparatus is data of an MBS, an initial value of a sequence number part of the first state variable as a first value, and
setting, based on a fact that the data to be received from the base station apparatus is at least not the data of the MBS, the initial value of the first state variable to 0,
the first state variable is a state variable indicating a COUNT value of a PDCP SDU expected to be received next,
the first value is a remainder obtained by dividing, by a second value, a value obtained by incrementing 1 to a sequence number of a PDCP data PDU received first,
the second value is 2 to a power of a third value, and
the third value is a downlink PDCP sequence number size.

2. A base station apparatus for communicating with a terminal apparatus, the base station apparatus comprising:
a transmitter configured to transmit data to the terminal apparatus; and
processing circuitry, wherein
the processing circuitry maintains, in a receiving PDCP entity of the terminal apparatus, a first state variable, based on the data to be transmitted to the terminal apparatus, and
the processing circuitry performs processing of, in the maintaining,
setting, based on a fact that the data to be transmitted to the terminal apparatus is data of an MBS, an initial value of a sequence number part of the first state variable as a first value, and
setting, based on a fact that the data to be transmitted to the terminal apparatus is at least not the data of the MBS, the initial value of the first state variable to 0,
the first state variable is a state variable indicating a COUNT value of a PDCP SDU expected to be received next by the terminal apparatus,
the first value is a remainder obtained by dividing, by a second value, a value obtained by incrementing 1 to a sequence number of a PDCP data PDU received first by the terminal apparatus,
the second value is 2 to a power of a third value, and
the third value is a downlink PDCP sequence number size.

3. A method applied to a base station apparatus for communicating with a terminal apparatus, the method comprising:
transmitting data to the terminal apparatus;
maintaining a first state variable, in a receiving PDCP entity of the terminal apparatus, based on the data to be transmitted to the terminal apparatus; and
performing processing of, in the maintaining,
setting, based on a fact that the data to be transmitted to the terminal apparatus is data of an MBS, an initial value of a sequence number part of the first state variable as a first value, and
setting, based on a fact that the data to be transmitted to the terminal apparatus is at least not the data of the MBS, the initial value of the first state variable to 0, wherein
the first state variable is a state variable indicating a COUNT value of a PDCP SDU expected to be received next by the terminal apparatus,
the first value is a remainder obtained by dividing, by a second value, a value obtained by incrementing 1 to a sequence number of a PDCP data PDU received first by the terminal apparatus,
the second value is 2 to a power of a third value, and
the third value is a downlink PDCP sequence number size.
